(19) United States
(12) Patent Application Publication
(10) Pub. No.: US 2024/0209148 A1
(43) Pub. Date: Jun. 27, 2024

(54) RESIN COMPOSITION FOR LOW-DIELECTRIC MATERIAL, FILM FOR MULTILAYER SUBSTRATE, MULTILAYER SUBSTRATE, METHOD FOR PRODUCING RESIN COMPOSITION FOR LOW-DIELECTRIC MATERIAL, METHOD FOR PRODUCING FILM FOR MULTILAYER SUBSTRATE, AND METHOD FOR PRODUCING MULTILAYER SUBSTRATE

(71) Applicant: NATIONAL UNIVERSITY CORPORATION, IWATE UNIVERSITY, Morioka-shi, Iwate (JP)

(72) Inventors: Yoshiyuki OISHI, Morioka-shi (JP); Yuji SHIBASAKI, Morioka-shi (JP); Tadashi TSUKAMOTO, Morioka-shi (JP)

(21) Appl. No.: 18/551,810

(22) PCT Filed: Mar. 23, 2022
(86) PCT No.: PCT/JP2022/013425

§ 371 Date: Mar. 5, 2024

(30) Foreign Application Priority Data
Mar. 24, 2021 (JP) 2021-050547

(51) Int. Cl. C08G 65/40; C08G 61/12; C08L 71/10

(52) U.S. Cl. CPC C08G 65/40; C08G 61/122; C08L 71/10; C08L 2201/08; C08L 2201/10; C08L 2203/16; C08L 2203/206

(57) ABSTRACT

Provided are a resin composition which has a low dielectric constant, a low dielectric loss tangent, high transparency, high solubility, and high heat resistance and can be used suitably as a low-dielectric material, a film for a multilayer substrate, in which the resin composition is used, a multilayer substrate, and methods for producing the same. A resin composition for a low-dielectric material, which contains a triazine-containing polyether compound having a specific repeating unit, a film for a multilayer substrate, a multilayer substrate, a method for producing a resin composition for a low-dielectric material, a method for producing a film for a multilayer substrate, and a method for producing a multilayer substrate.

### TECHNICAL FIELD

The present invention relates to a resin composition for a low-dielectric material including a triazine-containing polyether compound, which is for use as a low-dielectric material for electronic devices and the like, a film for a multilayer substrate, a multilayer substrate, a method for producing a resin composition for a low-dielectric material, a method for producing a film for a multilayer substrate, and a method for producing a multilayer substrate.

Priority is claimed on Japanese Patent Application No. 2021-050547 filed Mar. 24, 2021, the content of which is incorporated herein by reference.

### BACKGROUND ART

Among resin materials, aromatic polyethers have excellent heat resistance and also have comparatively excellent mechanical strength and the like and thus are widely used as so-called engineering resins in the automotive fields, mechanical fields, and the like. As a more preferable engineering resin, development of a new structure that is a superior engineering resin combining both heat resistance and thermal stability is in progress.

Patent Document 1 discloses a phenyltriazine compound bonded to an aryl group. This technique aims to provide an aromatic polyether resin which has excellent heat resistance and thermal stability as well as excellent mechanical strength and the like and which is able to be advantageously used as an engineering resin.

Meanwhile, as the communication infrastructure of society shifts to 5G, among the electromagnetic waves used in electronic devices, high-frequency regions such as microwaves and millimeter waves are attracting attention and research into uses in communication fields, radar for vehicles, and the like is also in progress. In devices using high-frequency regions, there is a demand for members such as substrates, resonators, filters, and antennas to have a low dielectric constant and a low dielectric loss tangent. At the same time, there is a demand for the materials used for these members to have a combination of various mechanical properties, for example, physical strength, thermal properties, and the like. As materials that satisfy such properties, materials in which a ceramic filler or the like is added to a resin material or the like are currently being considered.

### CITATION LIST

### Patent Document

### [Patent Document 1]

Japanese Unexamined Patent Application, First Publication No. H06-184300

### SUMMARY OF INVENTION

### Technical Problem

Meanwhile, research is in progress into organic materials, in particular, resin materials, which have excellent properties for use in electronic devices and electronic components in the high-frequency regions. Among the above, there is a particularly strong demand for materials having a low dielectric property and materials having a low dielectric loss tangent, which are able be used for insulating components, printed wiring boards, and the like.

Among resin materials having excellent properties, the present inventors searched for materials having a low dielectric property and materials having a low dielectric loss tangent. As a result, it was found that a triazine-containing polyether compound having a specific structure has not only excellent mechanical and thermal properties, but also excellent properties as a low dielectric constant material and a low dielectric loss tangent material, thereby completing the present invention.

The present invention was created in view of the above circumstances and has an object of providing a resin composition which has a low dielectric constant, a low dielectric loss tangent, high transparency, high solubility, and high heat resistance and is thus able to be used suitably as a low-dielectric material; a film for a multilayer substrate, in which the resin composition is used; a multilayer substrate; and methods for producing the same.

### Solution to Problem

In order to solve the above problems, the present invention has the following aspects.

[1] A resin composition for a low-dielectric material including a triazine-containing polyether compound having a repeating unit represented by General Formula (1),

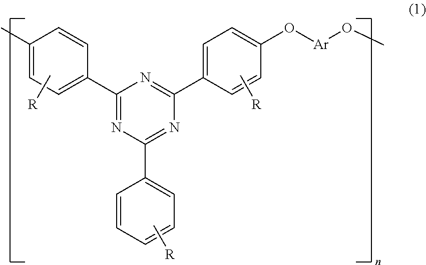

[In Formula (1), n is an integer of 2 or more, and Ar represents a divalent aromatic group having or not having a substituent. R represents hydrogen, a linear, branched, or cyclic aliphatic group, an aromatic group having or not having a substituent, a fluorinated aliphatic group, or a fluorinated aromatic group].

[2] The resin composition for a low-dielectric material, in which the Ar includes a triazine-containing polyether compound represented by any of General Formulas (2) to (15),

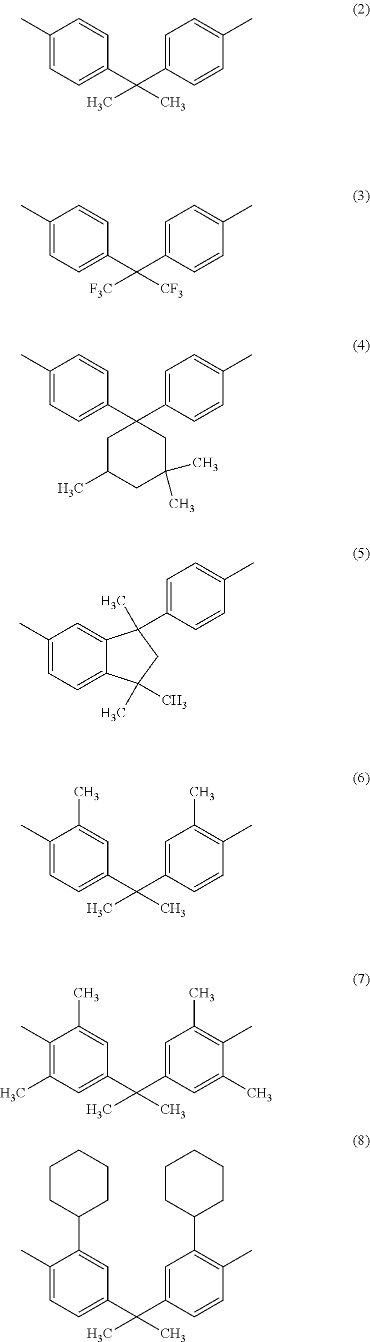

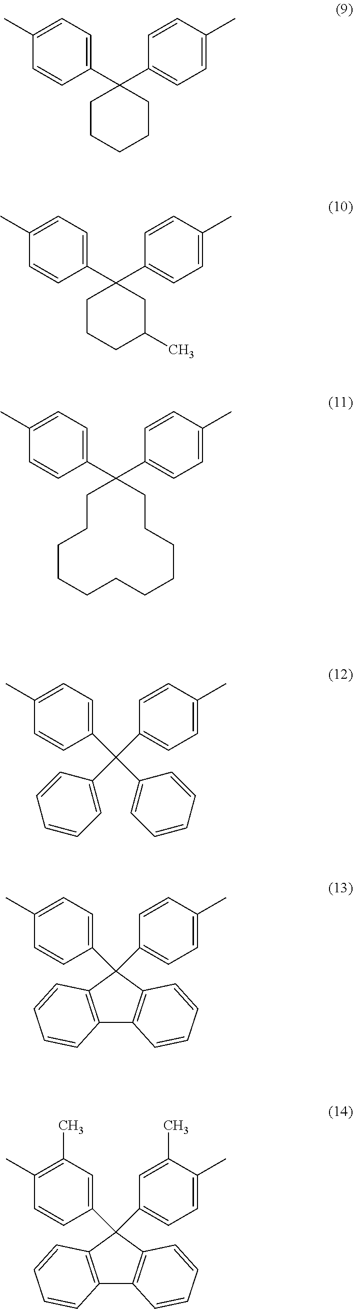

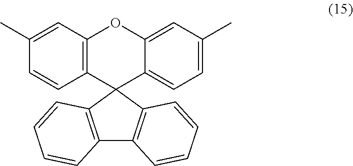

[3] The resin composition for a low-dielectric material, further including a triazine-containing polyether compound in which an average polymerization degree of the repeating unit represented by General Formula (1), which is indicated by n, is 2 to 200.

[4] The resin composition for a low-dielectric material, in which the triazine-containing polyether compound has a dielectric constant Dₖ of 2.8 or less and/or a dielectric loss tangent D_{f} of 0.003 or less.

[5] The resin composition for a low-dielectric material, in which the triazine-containing polyether compound has a glass transition temperature of 200° C. or higher.

[6] The resin composition for a low-dielectric material, further including the triazine-containing polyether compound, an epoxy resin, and a bismaleimide resin or a cyanate resin.

[7] The resin composition for a low-dielectric material, further including an inorganic filler, a modifier, or a flame retardant.

[8] The resin composition for a low-dielectric material, which is used in a device that transmits and receives high-frequency electromagnetic waves having a frequency of 0.1 to 500 GHz.

[9] The resin composition for a low-dielectric material, which is used for a printed wiring board, a flexible printed wiring board, a sealing material for an electronic component, a resist ink, a conductive paste, an insulating material, or an insulating board.

[10] A film for a multilayer substrate, including, on at least one surface, an insulating material including the resin composition for a low-dielectric material.

[11] A multilayer substrate including two or more of the films for a multilayer substrate.

[12] A method for producing the resin composition for a low-dielectric material, which is a method for producing the resin composition for a low-dielectric material, the method including mixing and polymerizing a compound represented by General Formula (16) and a compound represented by General Formula (17) to obtain a triazine-containing polyether compound represented by General Formula (18),

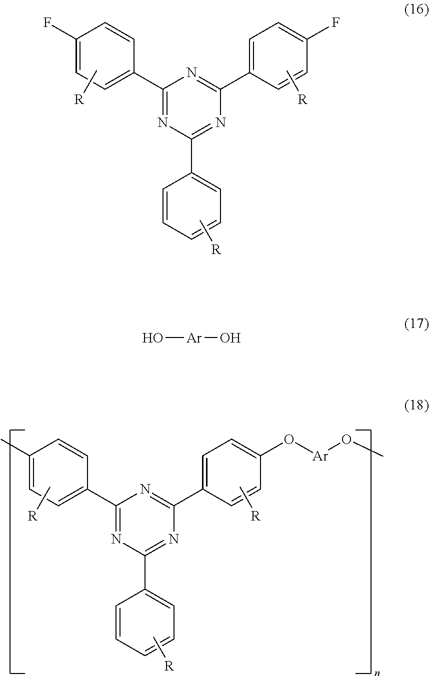

[In Formulas (16), (17), and (18), n is an integer of 2 or more, and Ar represents a divalent aromatic group having or not having a substituent. R represents hydrogen, a linear, branched, or cyclic aliphatic group, an aromatic group having or not having a substituent, a fluorinated aliphatic group, or a fluorinated aromatic group].

[13] The method for producing a resin composition for a low-dielectric material, in which the resin composition for a low-dielectric material is used as an insulating material between layers of a multilayer substrate, and the triazine-containing polyether compound, an epoxy resin, a bismaleimide resin or a cyanate resin, a curing accelerator, and an organic solvent are mixed.

[14] The method for producing a resin composition for a low-dielectric material, in which an inorganic filler, a modifier, or a flame retardant are further mixed.

[15] A method for producing a film for a multilayer substrate, the method including applying an insulating material including the resin composition for a low-dielectric material onto at least one surface of a resin film.

[16] A method for producing a multilayer substrate, the method including laminating two or more of the films for a multilayer substrate.

### Advantageous Effects of Invention

According to the present invention, it is possible to obtain a resin composition which has a low dielectric constant, a low dielectric loss tangent, high transparency, high solubility, and high heat resistance and is thus able to be used suitably as a low-dielectric material; a film for a multilayer substrate, in which the resin composition is used; a multilayer substrate; and methods for producing the same.

### BRIEF DESCRIPTION OF DRAWINGS

FIG. 1 is a diagram showing FT-IR spectra of Reference Examples 1 to 4 of the Examples.

### DESCRIPTION OF EMBODIMENTS

A description will be given below of the resin composition for a low-dielectric material according to the present invention and the production method thereof with reference to embodiments. However, the present invention is not limited to the following embodiments.

### (Resin Composition for Low-Dielectric Material)

The resin composition for a low-dielectric material of the present embodiment includes a specific triazine-containing polyether compound.

Here, a low-dielectric material is a material having a low dielectric constant and/or a low dielectric loss tangent. That is, a low-dielectric material is a low dielectric constant material or a low dielectric loss tangent material, collectively referred to below as a “low-dielectric material”. A description will be given below of definitions such as the conditions for measuring the dielectric constant. A low-dielectric material is used in a portion of an electronic device or electronic component for which there is a demand for a low dielectric constant and/or a low dielectric loss tangent. Examples of portions for which there is a demand for a low dielectric constant and/or a low dielectric loss tangent include portions that require insulation, such as insulating components such as insulating boards and insulating components of a printed wiring board. Printed wiring boards also include flexible printed wiring boards. Since the compound included in the material of the present embodiment has a low dielectric constant and/or a low dielectric loss tangent, particularly at high frequencies, the compound is preferably used as electronic components and electronic devices, in particular, in high-frequency compatible electronic components and electronic devices.

The triazine-containing polyether compound included in the resin composition of the present embodiment has a repeating unit represented by General Formula (1).

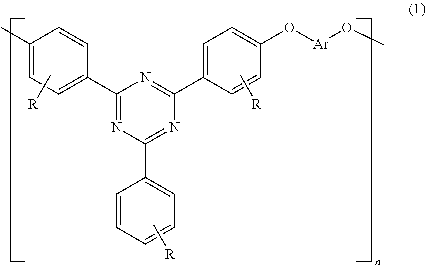

Here, in Formula (1), n is an integer of 2 or more, and Ar is an arylene group and represents a divalent aromatic group having or not having a substituent. Here, the substituent is a group of a group different from the group (atomic group) to be bonded and broadly refers to a group which is able to be bonded in a form in which some atoms (preferably hydrogen) of the bonding target group are replaced. An aromatic group broadly refers to a group including the structure of a compound or partially substituted compound having an aromatic property. Aliphatic groups broadly refer to groups including structures of organic compounds or partially substituted compounds that do not have an aromatic property.

In the formulas, n represents the number of repeating units of the structure represented by Formula (1) and is an integer of 2 or more. As described below, the average value of a degree of polymerization n of the triazine-containing polyether compound included in the resin composition for a low-dielectric material of the present embodiment is the average polymerization degree and the value of the average polymerization degree is preferably 2 to 200 and may be 2 to 100.

R is an organic substituent, which may be hydrogen or may be a linear, branched, or cyclic aliphatic group. In addition, R may be an aromatic group having or not having a substituent. Additionally, R may be any of the fluorinated aliphatic groups or any of the fluorinated aromatic groups. The degree to which R is fluorinated may be selected widely from one of the carbon bond sites included in R to all of the carbon bond sites other than sites bonded to the bonding target group. For example, in a case where R is a methyl group, 1 to 3 sites in the hydrogen of the methyl group may be substituted with fluorine, preferably 2 to 3 sites.

R in Formula (1) may be the same substituent or different.

It is possible to identify the above-described chemical structure of the triazine-containing polyether compound included in the resin composition of the present embodiment using an infrared spectrum (FT-IR), a nuclear magnetic resonance spectrum (NMR, for example, ¹H-NMR, ¹³C-NMR, or ¹⁹F-NMR), elemental analysis, or the like.

As examples of the arylene group of Ar, it is possible to appropriately select from various divalent aromatic group residues obtained by extracting a total of two hydrogen atoms or other substituents bonded to aromatic rings in various aromatic compounds or aromatic ring-containing compounds. As examples of arylene groups, it is possible to appropriately select from various phenylene groups, naphthylene groups, biphenylene groups, and the like. Ar may be bonded to other alkyl groups, alkylene groups, alkylidene groups, cycloalkyl groups, cycloalkylene groups, cycloalkylidene groups, aryl groups, arylene groups, fluorinated alkyl groups, fluorinated alkylene groups, fluorinated aryl groups, fluorinated arylene groups, or the like.

The triazine-containing polyether compound of the present embodiment may be a triazine-containing polyether compound in which Ar is represented by any one of General Formulas (2) to (15).

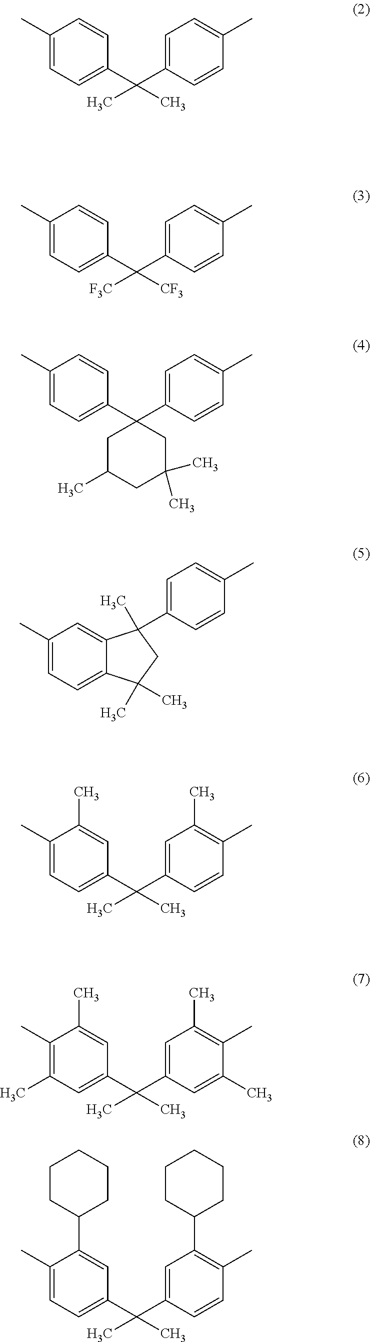

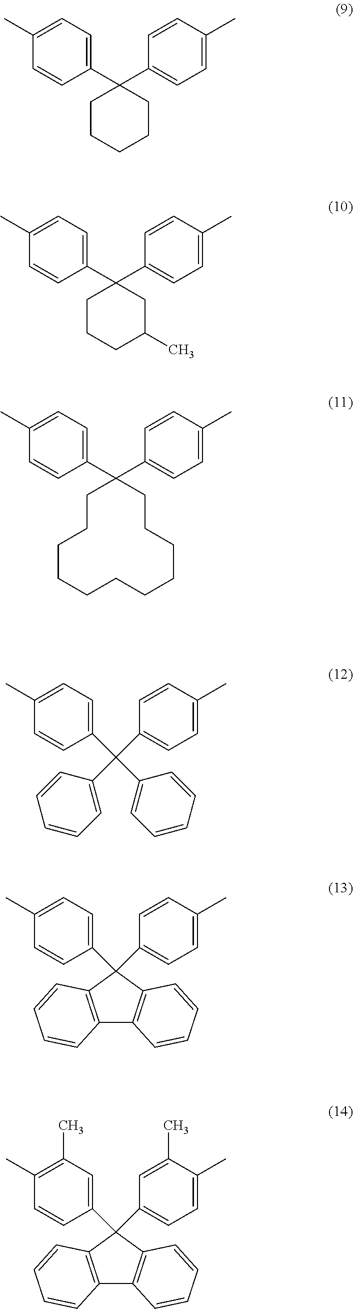

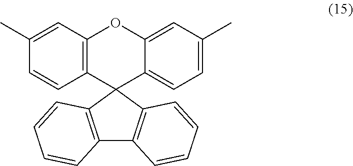

Here, regarding Ar represented by each formula, Ar in the above formulas may be expressed by BisA in Formula (2), by BisAF in Formula (3), by BisPHTG in Formula (4), by BisPIND in Formula (5), by BisC in Formula (6), by TMBisA in Formula (7), by BisCHP in Formula (8), by BisZ in Formula (9), by BisP3MZ in Formula (10), by BisP-CDE in Formula (11), by DTPM in Formula (12), by BPFL in Formula (13), by DMBPFL in Formula (14), and by TBISRX in Formula (15), which are dihydric phenols (HO—Ar—OH). In a case where Ar having these structures is used in the resin composition of the present embodiment for a low-dielectric material, a resin composition for a low-dielectric material including a triazine-containing polyether compound having a particularly low dielectric constant, a low dielectric loss tangent, and high heat resistance is obtained.

The triazine-containing polyether compound of the present embodiment preferably has an average polymerization degree of 2 to 200 for repeating units represented by n in General Formula (1).

When the average polymerization degree of the repeating units represented by n is 2 to 200, it is possible to obtain a compound having an appropriate molecular weight in a case of being used as a resin composition for a low-dielectric material.

As a guide, the molecular weight of the triazine-containing polyether compound of the present embodiment is preferably a number average molecular weight (Mₙ) of 3×10³ to 40×10⁴ when Ar in Formulas (2) to (15) is used and more preferably 3×10³ to 20×10⁴. The weight average molecular weight (M_{w}) is preferably 6×10³ to 40×10⁴ and more preferably 6×10³ to 40×10⁴. It is possible to measure the molecular weight of the compound of the present embodiment using gel permeation chromatography (GPC) or the like. It is possible to determine the average polymerization degree from this molecular weight and the structure of the compound described above.

The triazine-containing polyether compound of the present embodiment preferably has a dielectric constant Dₖ of 2.8 or less and/or a dielectric loss tangent D_{f} of 0.003 or less.

Here, the dielectric constant Dₖ and the dielectric loss tangent D_{f} are values measured with an existing dielectric characteristic measurement apparatus. As an existing dielectric characteristic measurement apparatus, for example, it is possible to use a cavity resonator-type apparatus or the like.

In addition, the triazine-containing polyether compound of the present embodiment preferably has a dielectric constant Dₖ of 2.7 or less. The dielectric loss tangent D_{f} is preferably 0.003 or less and more preferably 0.002 or less. Specifically, as another aspect of the present embodiment, the triazine-containing polyether compound may have a dielectric constant Dₖ of 2.7 or less and a dielectric loss tangent D_{f} of 0.002 or less.

The triazine-containing polyether compound of the present embodiment preferably has a glass transition temperature of 200° C. or higher and more preferably 260° C. or higher. In addition, the 5% thermal decomposition temperature is also preferably 400° C. to 600° C.

It is possible to measure the glass transition temperature of the triazine-containing polyether compound of the present embodiment using differential scanning calorimetry measurement (DSC), thermomechanical analysis (TMA), dynamic mechanical analysis (DMA), or the like.

The 5% thermal decomposition temperature of the triazine-containing polyether compound of the present embodiment is obtained by measuring the weight loss temperature. It is possible to measure the weight loss temperature using, for example, thermogravimetric analysis (TGA) or the like.

The resin composition for a low-dielectric material of the present embodiment preferably also includes the triazine-containing polyether compound, an epoxy resin, a bismaleimide resin or a cyanate resin, or the like. By containing an epoxy resin, a resin composition for a low-dielectric material having excellent heat resistance, mechanical properties, and dielectric properties is obtained.

The epoxy resin is not particularly limited, but in that it is possible to obtain a cured product having excellent heat resistance, for example, bisphenol A-type epoxy resin, bisphenol F-type epoxy resin, bisphenol E-type epoxy resin, bisphenol S-type epoxy resin, bisphenol sulfide-type epoxy resin, biphenyl-type epoxy resin, tetramethylbiphenyl-type epoxy resin, polyhydroxynaphthalene-type epoxy resin, phenol novolac-type epoxy resin, cresol novolac-type epoxy resin, bisphenol A novolac-type epoxy resin, triphenylmethane-type epoxy resin, tetraphenylethane-type epoxy resin, dicyclopentadiene-phenol addition reaction-type epoxy resin, phenol aralkyl-type epoxy resin, biphenyl aralkyl-type epoxy resin, biphenyl novolac-type epoxy resin, naphthol novolac-type epoxy resin, naphthol aralkyl-type epoxy resin, naphthol-phenol-co-condensed novolac-type epoxy resin, naphthol-cresol co-condensed novolac-type epoxy resin, biphenyl-modified phenol-type epoxy resin (polyhydric phenol-type epoxy resin in which a phenol skeleton and a biphenyl skeleton are linked by a bismethylene group), biphenyl-modified naphthol-type epoxy resin (polyhydric naphthol-type epoxy resin in which a naphthol skeleton and a biphenyl skeleton are linked by a bismethylene group), alkoxy group-containing aromatic ring-modified novolac-type epoxy resin (compound in which a glycidyl group-containing aromatic ring and an alkoxy group-containing aromatic ring are linked by formaldehyde), phenylene ether-type epoxy resin, naphthylene ether-type epoxy resin, aromatic hydrocarbon formaldehyde resin-modified phenol resin-type epoxy resin, xanthene-type epoxy resin, or the like may be used. The above may each be used alone or two or more may be used in combination.

The bismaleimide resin is not particularly limited, but in that it is possible to obtain a cured product having excellent heat resistance, for example, diphenylmethane-type bismaleimide resin, metaphenylene-type bismaleimide resin, bisphenol A diphenyl ether-type bismaleimide resin, diphenyl ether-type bismaleimide resin, a diphenylsulfone-type bismaleimide resin, a diphenoxybenzene-type bismaleimide resin, an aniline novolac-type bismaleimide resin, or the like may be used. The above may each be used alone or two or more may be used in combination.

The cyanate resin is not particularly limited, but in that it is possible to obtain a cured product having excellent heat resistance, for example, bisphenol A-type cyanate resin, tetramethylbisphenol F-type cyanate resin, hexafluorobisphenol A-type cyanate resin, bisphenol E-type cyanate resin, bisphenol M-type cyanate resin, novolac-type cyanate resin, cyclopentadienylbisphenol-type cyanate resin, or the like may be used. The above may each be used alone or two or more may be used in combination.

The resin composition for a low-dielectric material of the present embodiment preferably further includes an inorganic filler, a modifier, or a flame retardant.

As the inorganic filler, for example, fused silica, crystalline silica, alumina, silicon nitride, aluminum hydroxide, magnesium hydroxide, or the like may be used.

It is possible to appropriately select the modifier from various thermosetting resins, thermoplastic resins, and the like and, for example, phenoxy resins, polyamide resins, polyimide resins, polyetherimide resins, polyethersulfone resins, polyphenylene ether resins, polyphenylene sulfide resins, polyester resins, polystyrene resins, polyethylene terephthalate resins, cycloolefin resins, fluorine resins, or the like may be used.

It is possible to appropriately select the flame retardant from, for example, halogen compounds, phosphorus atom-containing compounds, nitrogen atom-containing compounds, inorganic flame retardant compounds, and the like, for example, halogen compounds such as tetrabromo bisphenol A-type epoxy resin and brominated phenol novolac-type epoxy resin; phosphate esters such as trimethyl phosphate, triethyl phosphate, tributyl phosphate, tri-2-ethylhexyl phosphate, tributoxyethyl phosphate, triphenyl phosphate, tricresyl phosphate, trixylenyl phosphate, cresyl diphenyl phosphate, xylenyl diphenyl phosphate, 2-ethylhexyldiphenyl phosphate, tris(2,6-dimethylphenyl) phosphate, and resorcin diphenyl phosphate; phosphorus atom-containing compounds such as condensed phosphoric acid such as ammonium polyphosphate, polyphosphate amide, red phosphorus, guanidine phosphate, or dialkylhydroxymethyl phosphonate, or ester compounds; nitrogen atom-containing compounds such as melamine; inorganic flame retardant compounds such as aluminum hydroxide, magnesium hydroxide, zinc borate, or calcium borate; and the like may be used.

The resin composition for a low-dielectric material of the present embodiment is preferably used in devices that transmit and receive high frequency electromagnetic waves having a frequency of 0.1 to 500 GHz.

Specifically, the resin composition for a low-dielectric material of the present embodiment is preferably used for devices that transmit and receive microwave or millimeter wave electromagnetic waves. Here, microwaves generally refer to electromagnetic waves having a frequency of 0.25 to 100 GHz and millimeter waves refer to electromagnetic waves having a frequency of 30 to 300 GHz and use in devices that perform such transmission and reception is even more preferable. It is also possible to suitably use the resin composition for a low-dielectric material of the present embodiment in devices using electromagnetic waves of frequencies such as 60 GHz used for wireless LANs and 75 to 79 GHz used for vehicle radars.

The resin composition for a low-dielectric material of the present embodiment has a sufficiently low dielectric constant and dielectric loss tangent and is particularly suitable for use for high-frequency electromagnetic waves.

The resin composition for a low-dielectric material of the present embodiment is preferably used for a printed wiring board, a flexible printed wiring board, a sealing material for an electronic component, a resist ink, a conductive paste, an insulating material, or an insulating board. The resin composition for a low-dielectric material of the present embodiment has a sufficiently low dielectric constant and dielectric loss tangent and is suitable for use in these members. Furthermore, the resin composition for a low-dielectric material is particularly suitable for use in these members in devices that use high-frequency electromagnetic waves.

As more specific examples, use is possible as a resin composition for copper-clad laminates, an interlayer insulating material for build-up printed substrates, a build-up film, and the like. In addition, use is also possible as a resin composition for a sealing material for electronic components, a resin composition for resist ink, a bonding agent for friction materials, a conductive paste, a resin casting material, an adhesive, a coating material such as an insulating paint, or the like.

The resin composition for a low-dielectric material of the present embodiment is preferably used as an insulating material between layers of a multilayer substrate. In such a case, the resin composition is preferably adjusted by mixing the triazine-containing polyether compound, the epoxy resin, the bismaleimide resin or the cyanate resin, the curing accelerator, and the organic solvent, as in the production method described below.

### (Film for Multilayer Substrate)

The film for a multilayer substrate of the present embodiment is provided with an insulating material including the resin composition for a low-dielectric material on at least one surface. By laminating a plurality of films for a multilayer substrate, it is possible to use the result for a multilayer substrate described below.

The film for a multilayer substrate is formed of a film layer described below and an insulating layer having an insulating material. The insulating layer is provided on at least one surface of the film layer by the production method described below.

It is possible to form the film layer using an appropriately selected film material, for example, a resin film, a metal film, or the like. Specifically, formation is possible using polyethylene, polypropylene, polyvinyl chloride, polycycloolefin, polyethylene terephthalate (PET), polyethylene naphthalate, polycarbonate, polyimide, release paper, copper foil, aluminum foil, or the like.

The thickness of the film for a multilayer substrate of the present embodiment is not particularly limited, but is able to be selected from a range of 10 μm to 150 μm and preferably a range of 25 μm to 50 μm.

The film for a multilayer substrate of the present embodiment may further be provided with a protective film on a surface thereof. The protective film makes it possible to prevent dust or the like attaching to and scratching the surface of the film layer and the insulating layer before use and to prevent the insulation performance or the like deteriorating before use. The constituent material of the protective film may be selected from the same materials as the film layer described above. The thickness of the protective film may be in a range of 1 μm to 40 μm.

The film for a multilayer substrate and protective film may be subjected to a matte treatment, a corona treatment, a release treatment, or the like.

In addition, when the multilayer substrate is in the form of a conductor multilayer substrate or a build-up printed substrate, in which a conductor layer formed of a conductor such as metal and the insulating layer are laminated, a set combining the conductor layer and the insulating layer may also be a film for a multilayer substrate.

The resin composition for a low-dielectric material of the present embodiment has properties such as excellent physical properties, heat resistance, a low dielectric constant, and a low dielectric loss tangent and thus, in a multilayer substrate provided with two or more of the films for a multilayer substrate, the resin composition for a low-dielectric material is also extremely useful as an insulating material between layers formed of films for a multilayer substrate. Such an insulating material is preferably produced by blending, in particular, a resin composition for a low-dielectric material, an epoxy resin, and a bismaleimide resin or a cyanate resin as essential components and furthermore, an organic solvent and a curing accelerator described below, as necessary.

### (Multilayer Substrate)

The multilayer substrate of the present embodiment is provided with two or more of the films for a multilayer substrate. The multilayer substrate is preferably formed by laminating the films for a multilayer substrate. The film for a multilayer substrate may be an intermediate layer or a base layer in the multilayer substrate. In addition, the film for a multilayer substrate may be used for a layer on which a circuit is formed or a layer on which a circuit is not formed. It is possible to form the circuit by a metal plating treatment or the like.

In addition, it is also possible to use the multilayer substrate of the present embodiment as a conductor multilayer substrate. For example, use is possible as a multilayer substrate provided with an insulating layer formed of a prepreg including the resin composition for a low-dielectric material, and a conductor layer. In a prepreg for insulation, an insulating layer is formed by impregnating a resin composition for a low-dielectric material into a fiber base material such as glass cloth, glass non-woven fabric, aramid paper, aramid cloth, glass mat, or glass roving cloth. It is possible for the conductor layer to be formed of metal, for example, copper or the like.

In addition, it is also possible for the multilayer substrate of the present embodiment to be a multilayer substrate in the form of a build-up printed substrate. It is also possible to obtain a multilayer substrate in the form of a build-up printed substrate by alternately forming, on a wiring substrate, an insulating layer formed of a resin composition for a low-dielectric material and a plated conductor layer thereon. It is possible to arbitrarily select the configuration of the composition and the like of the insulating layer and conductor layer selected from the configurations described above.

### (Other Configurations)

It is possible to use the resin composition for a low-dielectric material of the present embodiment by appropriately mixing components known in the related art as raw materials for low-dielectric materials. As described above, in the resin composition for a low-dielectric material of the present embodiment, the main material has a high affinity with epoxy resin, bismaleimide resin, or cyanate resin, thus, it is possible to also anticipate an effect of improving the dielectric properties and thermal properties by mixing with a thermosetting resin-based material.

### (Action and Effect of Resin Composition for Low-Dielectric Material)

The resin composition for a low-dielectric material of the present embodiment has a low dielectric constant, a low dielectric loss tangent, high transparency, high solubility, and high heat resistance in the triazine-containing polyether and is thus able to be used suitably as a low-dielectric material. In addition, the triazine-containing polyether of the present embodiment has a low dielectric constant, a low dielectric loss tangent, high transparency, high solubility, and high heat resistance and is thus able to be used suitably as a printed wiring board.

Among polymer materials known in the related art, there are almost no materials that achieve both a glass transition temperature of over 260° C. and a dielectric loss tangent of less than 0.002; however, it is possible to achieve the above within the preferable ranges in the present embodiment.

Furthermore, the triazine-containing polyether of the present embodiment has, in particular, a low dielectric constant, a low dielectric loss tangent, high transparency, high solubility, and high heat resistance at high frequencies and is thus able to be suitably used as a constituent material for a high-frequency compatible electronic components or electronic devices.

### (Method for Producing Resin Composition for Low-Dielectric Material)

The method for producing a resin composition for a low-dielectric material of the present embodiment includes mixing and polymerizing a compound represented by General Formula (16) and a compound represented by General Formula (17) to obtain a triazine-containing polyether compound represented by General Formula (18).

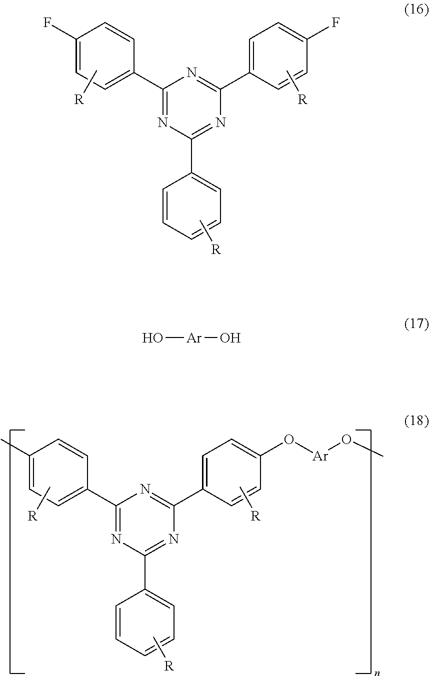

Here, in Formula (18), n is an integer of 2 or more, and Ar is an arylene group and represents a divalent aromatic group having or not having a substituent.

In the formula, n represents the number of repeating units of the structure represented by Formula (18) and is not particularly limited other than being an integer of 2 or more.

Examples of substituents include substituents having 1 to 18 carbon atoms. Preferable examples of substituents include alkyl groups such as methyl, alkylene groups such as methylene, alkylidene groups such as isopropylidene, cycloalkyl groups such as cyclohexyl, cycloalkylene groups such as cyclohexylene, cycloalkylidene groups such as cyclohexylidene, aryl groups such as phenyl, arylene groups such as phenylene, fluorinated alkyl groups such as trifluoromethyl, fluorinated alkylene groups such as perfluorohexylene, fluorinated aryl groups such as trifluoromethylphenyl, fluorinated arylene groups such as trifluoromethylphenylene, and the like.

R is an organic substituent, which may be hydrogen or may be a linear, branched, or cyclic aliphatic group. In addition, R may be an aromatic group having or not having a substituent. Additionally, R may be any of the fluorinated aliphatic groups or any of the fluorinated aromatic groups. Examples of organic substituents include organic substituents having 1 to 18 carbon atoms. Examples of preferable organic substituents include methyl groups, ethyl groups, propyl groups, isopropyl groups, butyl groups, isobutyl groups, sec-butyl groups, tert-butyl groups, pentyl groups, isopentyl groups, neopentyl group, tert-pentyl groups, hexyl groups, heptyl groups, octyl groups, nonyl groups, decyl groups, cyclobutyl groups, cyclopentyl groups, cyclohexyl groups, phenyl groups, methylphenyl groups, dimethylphenyl groups, cumenyl groups, mesityl groups, tert-butylphenyl groups, naphthyl groups, trifluoromethyl groups, trifluoromethylphenyl groups, bistrifluoromethylphenyl groups, trifluoromethylphenoxy groups, bistrifluoromethylphenoxy groups, and the like.

As a specific production step, for example, the compounds of Formula (16) and Formula (17) are mixed and polymerized by being heated and reacted in a polar solvent in the presence of an alkali metal compound to obtain the compound of Formula (18).

As the alkali metal compound, it is possible to use any compound as long as it is possible to replace the compound of Formula (17) with an alkali metal salt. Examples of such an alkali metal compound include an alkali metal carbonate, hydrogen carbonate, hydroxide, or the like and a carbonate is particularly preferably used. Possible examples of the alkali metal include lithium, sodium, potassium, rubidium, and cesium, among which, sodium and potassium are preferable.

As the above various alkali metal compounds, it is possible to use sodium carbonate, potassium carbonate, cesium carbonate, sodium hydrogen carbonate, potassium hydrogen carbonate, sodium hydroxide, potassium hydroxide or the like and it is possible to suitably use potassium carbonate or cesium carbonate in particular. These various alkali metal compounds may be used alone or in a combination of two or more.

As the polar solvent, it is possible to appropriately use a polar solvent with which it is possible for the polymerization reaction to smoothly proceed. Specific examples of polar solvents include 1,3-dimethyl-2-imidazolidone (DMI), tetramethyl urea (TMU), N,N′-dimethylpropylene urea (DMPU), N,N-dimethylformamide (DMF), N,N-dimethylacetamide (DMAc), N-methyl-2-pyrrolidone (NMP), N-cyclohexyl-2-pyrrolidone, N-methylcaprolactam, dimethylsulfoxide (DMSO), sulfolane (SUL), diphenylsulfone, and the like. Among the above, it is preferable to use DMI or NMP. These various polar solvents may be used alone or in a combination of two or more. In addition, use is also possible as a solvent mixed with other solvents (for example, aromatic solvents such as toluene or the like).

In addition, at an appropriate point while carrying out the reaction using the polar solvent, for example, an appropriate amount of an inert solvent component such as toluene or xylene may be added. By adding these solvents that easily form an azeotrope with water, it is possible to efficiently remove the water produced by the reaction from the reaction system.

It is possible to appropriately adjust the polymerization temperature depending on the compounds, additives, and solvents used; however, usually, the polymerization is preferably carried out at a temperature of 140° C. to 300° C. and more preferably at 180° C. to 250° C. When the temperature is less than this range, it is not possible to obtain a sufficient reaction rate and degree of polymerization, which is not efficient. In addition, when the temperature exceeds this range, the obtained compound may undergo decomposition, deterioration, or the like.

It is also possible to appropriately adjust the polymerization reaction time depending on the components used and the polymerization temperature, but the polymerization reaction time is usually approximately 0.1 to 20 hours. For example, in a case where NMP or DMI is used in a polar solvent, the polymerization proceeds sufficiently in 3 to 4 hours at a polymerization temperature of 190° C. to 200° C. In order to increase the molecular weight, it is preferable to carry out the polymerization for 15 to 20 hours, or, as appropriate, to use the state in which the polymerization is sufficiently performed, such as the stopping of the stirrer, as a measure of the completion of the polymerization.

As an example of a specific production process, first, an inert solvent component is added to the compounds of Formula (16) and Formula (17), an alkali metal compound, and a polar solvent and then heated and the polymerization temperature is increased stepwise from room temperature to 140° C. to 150° C. While maintaining the temperature, the inert solvent component and water form an azeotrope and are removed. Next, the temperature is raised to the polymerization temperature and the inert solvent component is completely removed while maintaining this temperature. After the inert solvent component is removed, the polymerization temperature is maintained and the polymerization is performed for the polymerization reaction time described above to obtain the compound of Formula (18). After the polymerization reaction is sufficiently completed, the result is cooled to room temperature and recovered using methanol. Thereafter, steps such as further washing with methanol or the like, drying under reduced pressure, and/or reprecipitation using an organic solvent may be performed.

### (Other Additives in Production Method)

In a case where the resin composition for a low-dielectric material of the present embodiment is used as an insulating material between layers of a multilayer substrate, the resin composition for a low-dielectric material is preferably produced by mixing a triazine-containing polyether compound, an epoxy resin, a bismaleimide resin or a cyanate resin, a curing accelerator, and an organic solvent.

By carrying out the production by mixing a curing accelerator, the curing reaction of the resin composition for a low-dielectric material proceeds quickly and is thus easy to produce as an insulating material. In particular, in a case where the insulating material is used as an insulating layer on the surface of a film for a multilayer substrate described below, the insulating layer is quickly formed, which is suitable for industrial production.

By carrying out the production by mixing an organic solvent, the resin composition for a low-dielectric material becomes a so-called varnish during production, which makes it easy to apply to other members as an insulating material. In particular, in a case where the insulating material is used as an insulating layer on the surface of a film for a multilayer substrate described below, the coating property is improved when the insulating layer is formed by application to the surface of the film.

As the curing accelerator, it is possible to appropriately use a compound capable of accelerating the curing of the above compounds and, for example, imidazoles, tertiary amines, acid anhydrides, tertiary phosphines, or the like may be used.

It is also possible to appropriately adjust the addition amount depending on the composition of the compound, but the addition amount is preferably in the range of 0.01% by mass to 2% by mass with respect to the total mass of the resin composition for a low-dielectric material.

As the organic solvent, it is possible to appropriately select a solvent capable of dissolving the above compound to form a varnish and, for example, it is possible to use known organic solvents such as alcohol-based solvents, ketones, acetate esters, carbitols, aromatic hydrocarbons, dimethylformamide, dimethylacetamide, or N-methylpyrrolidone. Among the above, it is possible to suitably use propylene glycol monomethyl ether acetate, cyclohexanone, or methyl ethyl ketone.

It is also possible to appropriately adjust the addition amount depending on the composition of the compound; however, in order to form a varnish, the non-volatile content is preferably in the range of 50% by mass to 70% by mass with respect to the total mass of the resin composition for a low-dielectric material.

The resin composition for a low-dielectric material of the present embodiment is also preferably produced by further mixing an inorganic filler, a modifier, or a flame retardant.

As the inorganic filler, it is possible to use, for example, fused silica, crystalline silica, alumina, silicon nitride, aluminum hydroxide, or magnesium hydroxide. In a case where the resin composition for a low-dielectric material is used for uses such as conductive pastes and conductive films, it is possible to use conductive fillers such as silver powder and copper powder as inorganic fillers.

As modifiers, it is possible to use, for example, phenoxy resins, polyamide resins, polyimide resins, polyetherimide resins, polyethersulfone resins, polyphenylene ether resins, polyphenylene sulfide resins, polyester resins, polystyrene resins, polyethylene terephthalate resins, and the like.

As flame retardants, it is possible to use, for example, halogen compounds, phosphorus atom-containing compounds, nitrogen atom-containing compounds, inorganic flame retardant compounds, or the like.

### (Method for Producing Film for Multilayer Substrate)

In the method for producing a film for a multilayer substrate of the present embodiment, an insulating material including a resin composition for a low-dielectric material is applied to at least one surface of a resin film.

Specifically, in the production method, the varnish-like resin composition for a low-dielectric material is applied to at least one surface of the resin film as described above. Next, it is possible to carry out the production by volatilizing the organic solvent by heating, blowing hot air, or the like to form an insulating layer.

Here, the resin composition for a low-dielectric material preferably has a non-volatile content in a range of 30% by mass to 60% by mass, excluding volatile components such as the organic solvent. When in this range, the coating property of the blended product on a film and the formability of a film for a multilayer substrate are particularly suitable.

The thickness of the insulating layer to be formed is preferably the thickness or greater of the conductor layer of the circuit substrate on which the multilayer substrate is provided, as described below. Assuming that the thickness of the conductor layer of the circuit substrate is usually in the range of 5 μm to 70 μm, the thickness of the resin composition layer is preferably 10 μm to 100 μm.

### (Method for Producing Multilayer Substrate)

In the method for producing a multilayer substrate of the present embodiment, two or more of the films for a multilayer substrate are laminated.

When producing a printed wiring board using the multilayer substrate of the present embodiment, in a case where the film for the multilayer substrate is protected by a protective film, it is possible to perform the production by peeling the protective film off and then carrying out lamination on one surface or both surfaces of the circuit substrate, for example, by a vacuum lamination method, such that the layer is directly in contact with the circuit substrate, or the like. The lamination method may be a batch-type or a continuous roll-type method. In addition, the film and circuit substrate may be heated (preheated) before performing the lamination, as necessary.

In a case of producing a conductor multilayer substrate, the conductor multilayer substrate may be formed by the following procedure. That is, an insulating layer of a prepreg cured product is obtained by impregnating the fiber base material with the resin composition for a low-dielectric material adjusted to be in the form of a varnish and carrying out heating at a heating temperature according to the type of solvent used, preferably at 50° C. to 170° C. As the fiber base material, it is possible to use paper, glass cloth, glass non-woven fabric, aramid paper, aramid cloth, matte-treated glass, glass roving cloth, or the like. At this time, the blending ratio of resin composition for a low-dielectric material and the fiber base material to be used is usually preferably adjusted such that the resin content in the prepreg is 20% by mass to 60% by mass.

It is possible to obtain the desired conductor plate multilayer substrate by laminating the obtained prepregs and further overlaying and heat-pressing a film of a material to be a conductor layer, for example, a copper foil. Here, a specific example of a heat-pressing method is a method performed under a temperature condition of 170° C. to 250° C. under a pressure of 1 MPa to 10 MPa. In addition, the heat-pressing is preferably performed for 10 minutes to 3 hours.

In a case of using the film for a multilayer substrate as a build-up printed substrate, the multilayer substrate and printed substrate may be formed using the following procedure. That is, a resin composition for a low-dielectric material is applied to a wiring substrate on which a circuit is formed using a spray coating method, a curtain coating method, or the like and then cured. Next, after drilling predetermined through hole portions or the like as necessary, a treatment using a roughening agent is carried out and the surface is washed with hot water to form uneven portions and then subjected to a treatment for plating a metal such as copper thereon. The plating method is preferably electroless plating or an electrolytic plating treatment. In addition, as the roughening agent, it is possible to use an oxidizing agent, an alkali, an organic solvent, or the like. Such an operation is repeated as desired to alternately build up and form insulating layers and conductor layers having a predetermined circuit pattern, thereby making it possible to obtain a build-up substrate. However, the drilling of the through hole portions is preferably performed after the formation of the outermost insulating layer, in addition, it is also possible to produce a build-up substrate by forming a roughened surface on the wiring substrate on which the circuit is formed by heat-pressing at 170° C. to 250° C. a copper foil having an attached resin in which the resin composition is semi-cured on a copper foil and omitting the step of the plating treatment.

### (Method for Producing Sealing Materials for Electronic Components and the Like)

Examples of a procedure for adjusting the resin composition for a low-dielectric material of the present embodiment as a sealing material for electronic components include pre-mixing the resin composition for a low-dielectric material, an epoxy resin, a bismaleimide resin or a cyanate resin, and other coupling agents and/or additives such as mold release agents, inorganic fillers, and the like to be blended as necessary and then sufficiently mixing the result until uniform using an extruder, a kneader, a roll, or the like. In a case of being used as a tape-shaped sealing agent for semiconductors, examples thereof include a method in which the resin composition obtained by the procedure described above is heated to produce a semi-cured sheet as a sealing agent tape and the sealing agent tape is placed on a semiconductor chip, softened and molded by heating to 100° C. to 150° C., and then completely cured at 170° C. to 250° C.

Examples of a method for adjusting the resin composition for a low-dielectric material of the present embodiment as a resist ink include further adding an organic solvent, a pigment, talc, a filler, and the like to the resin composition for a low-dielectric material, the epoxy resin, and the bismaleimide resin or the cyanate resin to form a resist ink composition and then applying the resist ink composition onto a printed substrate by a screen-printing method to form a resist ink cured product. Examples of the organic solvents used here include ethylene glycol monomethyl ether, ethylene glycol monoethyl ether, ethylene glycol monomethyl ether acetate, ethylene glycol monoethyl ether acetate, cyclohexanone, dimethylsulfoxide, dimethylformamide, dioxolane, tetrahydrofuran, propylene glycol monomethyl ether acetate, ethyl lactate, and the like.

In a case where the resin composition for a low-dielectric material of the present embodiment is used as an insulating material, for example, an insulating material between semiconductor layers, examples of methods include blending a curing accelerator and a silane coupling agent in addition to the resin composition for a low-dielectric material, the epoxy resin, and the bismaleimide resin or the cyanate resin to adjust a composition, which is applied to a silicon substrate by spin coating or the like. In this case, since the cured coating film is directly in contact with the semiconductor, it is preferable to make the coefficient of linear expansion of the insulating material close to the coefficient of linear expansion of the semiconductor such that cracks do not occur due to the difference in the coefficients of linear expansion in a high-temperature environment.

In a case where the resin composition for a low-dielectric material of the present embodiment is used as a conductive paste, examples thereof include a method in which fine conductive particles are dispersed in the resin composition for a low-dielectric material to form a composition for an anisotropic conductive film or a method for forming a paste resin composition for circuit connection or an anisotropic conductive adhesive which is liquid at room temperature.

### EXAMPLES

Examples are shown below. In addition, the present invention is not limited to the Examples.

### (Test Conditions)

The following instruments and reagents were used to synthesize the samples and analyze the synthesized samples.

The instruments and conditions used are as follows.
(1) GPC: High-speed GPC system HLC-8220GPC manufactured by Tosoh Corp., (column: Tosoh TSKgel (α-M), column temperature: 45° C., eluent: N-methyl-2-pyrrolidone (NMP) (including 0.01 mol/L lithium bromide), or tetrahydrofuran (THF), calibration curve: standard polystyrene, column flow rate: 0.2 mL/min)
(2) Infrared spectrum (FT-IR): FT/IR-4200 manufactured by JASCO Corp.
(3) Nuclear magnetic resonance spectrum (NMR): JNM-ECA500 manufactured by JEOL Ltd.
(4) Thermogravimetric analysis (TGA): TG/DTA7220 manufactured by Hitachi High-Tech Science Co., Ltd., heating rate 10° C./min
(5) Differential scanning calorimetry measurement (DSC): DSC7000 manufactured by Hitachi High-Tech Science Co., Ltd., heating rate 20° C./min
(6) Thermomechanical analysis (TMA): TMA7100 manufactured by Hitachi High-Tech Science Co., Ltd., heating rate 10° C./min
(7) Dynamic mechanical analysis (DMA): DMS7100 manufactured by Hitachi High-Tech Science Co., Ltd., heating rate 2° C./min
(8) Tensile test: Autograph AGS-D type manufactured by Shimadzu Corp., tensile speed 1 mm/min
(9) Ultraviolet-visible spectrum: UV-1800 manufactured by Shimadzu Corp.
(10) Refractive index measurement: Model 2010/M PRISM COUPLER manufactured by Metricon
(11) Dielectric constant measurement: dielectric constant/dielectric loss tangent measurement apparatus (cavity resonator-type) manufactured by AET Inc., TM mode (10 GHz), TE mode (10 GHz)

Commercially available reagents were used and purification was carried out by standard methods as necessary. Various reaction solvents were dried and purified by standard methods as necessary.

### (Production of Resin Composition)

Among the compounds of Formula (1), R=hydrogen (H) (BFPT) and Ar is adjusted to be each of
the BisA compound of Formula (2) (BFPT-BisA, Example 1)
the BisAF compound of Formula (3) (BFPT-BisAF, Example 2)
the BisPHTG compound of Formula (4) (BFPT-BisPHTG, Example 3)
the BisPIND compound of Formula (5) (BFPT-BisPIND, Example 4)
the BisC compound of Formula (6) (BFPT-BisC, Example 5)
the TMBisA compound of Formula (7) (BFPT-TMBisA, Example 6)
the BisCHP compound of Formula (8) (BFPT-BisCHP, Example 7)
a compound of BisZ of Formula (9) and BisAF of Formula (3) (BFPT-BisZ/BisAF, Example 8)
a compound of BisP3MZ of Formula (10) and BisAF of Formula (3) (BFPT-BisP3MZ/BisAF, Example 9)
the BisP-CDE compound of Formula (11) (BFPT-BisP CDE, Example 10)
the DTPM compound of Formula (12) (BFPT-DTPM, Example 11)
the BPFL compound of Formula (13) (BFPT-BPFL, Example 12)
the DMBPFL compound of Formula (14) (BFPT-DMBPFL, Example 13), and
the TBISRX compound of Formula (15) (BFPT-TBISRX, Example 14).

As the compounds of Formula (16) and Formula (17) used in the production, a compound (BFPT) in which R=hydrogen (H) was used as the compound of Formula (16). As a compound of Formula (17), for each Example, for Ar, the compounds of Formula (2) (Example 1), Formula (3) (Example 2), Formula (4) (Example 3), Formula (5) (Example 4), Formula (6) (Example 5), Formula (7) (Example 6), Formula (8) (Example 7), Formula (9) (Example 8), Formula (10) (Example 9), Formula (11) (Example 10), Formula (12) (Example 11), Formula (13) (Example 12), Formula (14) (Example 13), and Formula (15) (Example 14) were used.

### (Synthesis of 2,4-bis(4-fluorophenyl)-2-phenyl-1,3,5-triazine (BFPT))

BFPT used in each Example was synthesized as follows.

4-Fluorobenzamidine hydrochloride (7.460 g, 42.73 mmol), benzylideneaniline (3.625 g, 20.00 mmol), sodium hydrogen carbonate (3.781 g, 45.00 mmol), and N,N-dimethylformamide (DMF, 35 mL) were placed into a three-necked flask (100 mL) provided with a stirrer and a nitrogen gas inlet tube, the temperature was raised stepwise to 85° C., and a reaction was carried out at 85° C. for 96 hours. Thereafter, reaction solution was cooled to room temperature. The reaction solution was introduced into distilled water and chloroform was added thereto. The chloroform solution was washed three times with distilled water using a separating funnel. When the recovered chloroform solution was dried over anhydrous sodium sulfate overnight and the anhydrous sodium sulfate was removed by suction filtration and then the chloroform solution was concentrated by an evaporator and introduced into methanol (500 mL), a crude product was precipitated. When the precipitate was recovered by suction filtration, washed with methanol under reflux, and then dried under reduced pressure at room temperature, a crude product of brown needle crystals (1.61 g, 23.3%) was obtained. The crude product was recrystallized using a mixed solvent of chloroform and methanol and dried under reduced pressure at 80° C. for 24 hours.

The synthesized compound had a shape: white needle crystals, yield amount: 1.46 g, yield ratio: 21.1%, melting point: 258° C. to 259° C.

Regarding this BFPT, the analysis results using the instrument described above are

FT-IR (KBr, cm⁻¹): 3051 (Ar—H), 1603 (C═C), 1522 (C═N), 1508 (C═C), 1370 (C—N), 1228 (Ar—F)

¹H-NMR (CDCl₃, ppm): 8.78-8.73 (m, 6H), 7.61 (t, 1H), 7.57 (t, 2H), 7.26-7.23 (m, 4H)

¹³C-NMR (CDCl₃, ppm): 171.74, 170.75, 165.93, 136.06, 132.78, 132.35, 131.38, 128.89, 115.83

¹⁹F-NMR (CDCl₃, ppm): 108.41

Elemental analysis (C₂₁H₁₃F₂N₃): Calculated values C, 73.03%; H, 3.79%; N, 12.17% Measured values C, 73.02%; H, 3.89%; N, 12.40%.

### Example 1

The compound of Example 1, which was the polyether (BFPT-BisA) in the following formula, was synthesized as follows.

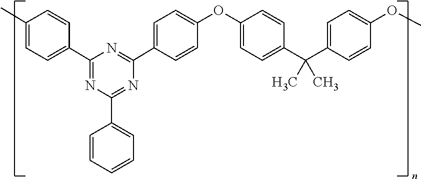

BFPT (0.6907 g, 2.00 mmol) and bisphenol A (0.4566 g, 2.00 mmol) were placed into a two-necked flask (50 mL) provided with a stirrer and a nitrogen gas inlet tube and potassium carbonate (0.3334 g, 2.40 mmol) as an alkali metal compound, N-methyl-2-pyrrolidone (NMP, 5.0 mL) as a polar solvent, and toluene (20 mL) as an inert solvent component were added thereto. A Dean-Stark trap and a Liebig condenser were attached and a nitrogen gas atmosphere was created. The temperature was raised stepwise to 150° C. while stirring, toluene was refluxed at 150° C. for 2 hours, and water was removed using the Dean-Stark trap. Thereafter, the temperature was raised to 190° C. and the result was stirred for 1 hour to remove toluene. Thereafter, polymerization was carried out at 190° C. for 2 hours. The result was left to cool to room temperature to obtain a viscous polymerization solution. The polymer was precipitated by being poured into methanol, recovered, and then washed with hot methanol and dried under reduced pressure at room temperature for 12 hours. The obtained polymer was dissolved in NMP and poured into methanol to precipitate a white flaky polymer. The polymer was recovered and then dried under reduced pressure at room temperature for 12 hours.

The synthesized compound had yield amount: 0.761 g, yield ratio: 71%, logarithmic viscosity: 1.12 dL/g (30° C., 0.5 g/dL NMP solution), number average molecular weight (Mₙ) measured by GPC (NMP) as described above: 75,000, weight average molecular weight (M_{w}): 133,000, molecular weight distribution (M_{w}/Mₙ): 1.8, average polymerization degree (n): 140.

This polymer was dissolved in NMP and a 12 wt % solution was prepared. This solution was cast on a glass plate, heated stepwise to 160° C. under reduced pressure, and dried under reduced pressure at 160° C. for 1 hour. The glass plate was immersed in distilled water and the film was peeled off and dried under reduced pressure at 200° C. for 3 hours to produce a colorless and transparent cast film (film thickness: 38 μm).

For this Example, the analysis results using the instruments described above were

FT-IR (film, cm⁻¹): 3066 (Ar—H), 2968 (C—H), 1592 (C═C), 1517 (C═N), 1504 (C═C), 1368 (C—N), 1241 (Ar—O)

¹H-NMR (CDCl₃, ppm): 8.68 (d, 6H), 7.53-7.50 (m, 3H), 7.24 (d, 4H), 7.09 (d, 4H), 7.00 (d, 4H), 1.69 (s, 6H)

Elemental analysis (C₃₆H₂₇O₂N₃)ₙ: Calculated values C, 81.02%; H, 5.10%; N, 7.88% Measured values C, 80.72%; H, 5.17%; N, 7.88%

Solubility: Soluble in N-methyl-2-pyrrolidone (NMP), tetramethyl urea (TMU), and N,N′-dimethylimidazolidone (DMI)

Glass transition temperature (T_{g}): 245° C. (DSC), 239° C. (DMA), 250° C. (TMA)

Coefficient of thermal expansion (CTE): 87 ppm/° C. (range from 150° C. to 200° C.)

5% weight loss temperature (T_{5%}): 448° C. (in air), 525° C. (in nitrogen)

10% weight loss temperature (T_{10%}): 486° C. (in air), 534° C. (in nitrogen)

Char yield (800° C. in nitrogen): 40%

Cutoff wavelength: 353 nm

Transmittance (500 nm): 81%

Average refractive index (nₐᵥₑ): 1.675 (d-line)

Birefringence (Δn): 0.015 (d-line)

Dielectric constant (ε=nₐᵥₑ²): 2.81

Dielectric constant (Dₖ): 2.78 (cavity resonator, TM mode, 10 GHz)

Dielectric constant (Dₖ): 2.58 (cavity resonator, TE mode, 10 GHz)

Dielectric loss tangent (D_{f}): 0.0026 (cavity resonator, TM mode, 10 GHz)

Dielectric loss tangent (D_{f}): 0.0024 (cavity resonator, TE mode, 10 GHz)

Tensile breaking strength: 61 MPa

Breaking elongation: 21.9%

Initial tensile modulus: 1.8 GPa.

### Example 2

The compound of Example 2, which was the polyether (BFPT-BisAF) in the following formula, was synthesized as follows.

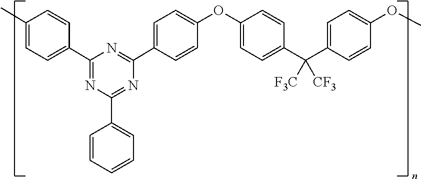

BFPT (0.6907 g, 2.0) mmol) and bisphenol AF (0.6725 g, 2.00 mmol) were placed into a two-necked flask (50 mL) provided with a stirrer and a nitrogen gas inlet tube and potassium carbonate (0.3334 g, 2.40 mmol) as an alkali metal compound, N,N′-dimethylimidazolidone (DMI, 6.5 mL) as a polar solvent, and toluene (20 mL) as an inert solvent component were added thereto. A Dean-Stark trap and a Liebig condenser were attached and a nitrogen gas atmosphere was created. The temperature was raised stepwise to 150° C. while stirring, toluene was refluxed at 150° C. for 2 hours, and water was removed using the Dean-Stark trap. Thereafter, the temperature was raised to 190° C. and the result was stirred for 1 hour to remove toluene. Thereafter, polymerization was carried out at 190° C. for 2 hours. The result was left to cool to room temperature to obtain a viscous polymerization solution. The polymer was precipitated by being poured into methanol, recovered, and then washed with hot methanol and dried under reduced pressure at room temperature. The obtained polymer was dissolved in tetramethyl urea (TMU) and poured into methanol to precipitate a white flaky polymer. The polymer was recovered and then dried under reduced pressure at room temperature.

The synthesized compound had yield amount: 1.021 g, yield ratio: 80%, logarithmic viscosity: 0.98 dL/g (30° C., 0.5 g/dL NMP solution), number average molecular weight (Mₙ) measured by GPC (THF) as described above: 106,000, weight average molecular weight (M_{w}): 211,000, molecular weight distribution (M_{w}/Mₙ): 2.0, average polymerization degree (n): 165.

The polymer was dissolved in TMU and a 9 wt % solution was prepared. This solution was cast on a glass plate, heated stepwise to 160° C. under reduced pressure, and dried under reduced pressure at 160° C. for 1 hour. The glass plate was immersed in distilled water and the film was peeled off and dried under reduced pressure at 200° C. for 3 hours to produce a colorless and transparent cast film (film thickness: 37 μm).

For this Example, the analysis results using the instruments described above were

FT-IR (film, cm⁻¹): 3064 (Ar—H), 1595 (C═C), 1518 (C═N), 1506 (C═C), 1368 (C—N), 1248 (Ar—O)

¹H-NMR (CDCl₃, ppm): 8.74-8.69 (m, 6H), 7.55-7.49 (m, 3H), 7.42 (d, 4H), 7.17 (d, 4H), 7.07 (d, 4H)

Elemental analysis (C₃₆H₂₁N₃O₂F₆)ₙ: Calculated values C, 67.40%; H, 3.29%; N, 6.55% Measured values C, 67.37%; H, 3.48%; N, 6.70%

Solubility: Soluble in N-methyl-2-pyrrolidone (NMP), tetramethyl urea (TMU), N,N′-dimethylimidazolidone (DMI), N,N-dimethylacetamide (DMAc), cyclohexanone, cyclopentanone, tetrahydrofuran (THF), and chloroform

Glass transition temperature (T_{g}): 248° C. (DSC), 249° C. (DMA), 280° C. (TMA)

Coefficient of thermal expansion (CTE): 72 ppm/° C. (range from 150° C. to 200° C.)

5% weight loss temperature (T_{5%}): 526° C. (in air), 534° C. (in nitrogen)

10% weight loss temperature (T_{10%}): 545° C. (in air), 548° C. (in nitrogen)

Char yield (800° C. in nitrogen): 62%

Cutoff wavelength: 343 nm

Transmittance (500 nm): 83%

Average refractive index (nₐᵥₑ): 1.621 (d-line)

Birefringence (Δn): 0.021 (d-line)

Dielectric constant (ε=nₐᵥₑ²): 2.63

Dielectric constant (Dₖ): 2.65 (cavity resonator, TM mode, 10 GHz)

Dielectric constant (Dₖ): 2.56 (cavity resonator, TE mode, 10 GHz)

Dielectric loss tangent (D_{f}): 0.0016 (cavity resonator, TM mode, 10 GHz)

Dielectric loss tangent (D_{f}) 0.0015 (cavity resonator, TE mode, 10 GHz)

Tensile breaking strength: 63 MPa

Breaking elongation: 6.1%

Initial tensile modulus: 2.1 GPa.

### Example 3

The compound of Example 3, which was the polyether (BFPT-BisPHTG) in the following formula, was synthesized as follows.

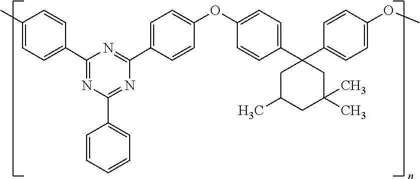

BFPT (0.6907 g, 2.00 mmol) and BisP-HTG (0.6209 g, 2.00 mmol) were placed into a two-necked flask (50 mL) provided with a stirrer and a nitrogen gas inlet tube and potassium carbonate (0.3334 g, 2.40 mmol) as an alkali metal compound, N-methyl-2-pyrrolidone (NMP, 5.0 mL) as a polar solvent, and toluene (20 mL) as an inert solvent component were added thereto. A Dean-Stark trap and a Liebig condenser were attached and a nitrogen gas atmosphere was created. The temperature was raised stepwise to 150° C. while stirring, toluene was refluxed at 150° C. for 2 hours, and water was removed using the Dean-Stark trap. Thereafter, the temperature was raised to 190° C. and the result was stirred for 1 hour to remove toluene. Thereafter, polymerization was carried out at 190° C. for 2 hours. The result was left to cool to room temperature to obtain a brown, viscous polymerization solution. The polymer was precipitated by being poured into methanol, recovered, and then washed with hot methanol and dried under reduced pressure at room temperature. The obtained polymer was dissolved in NMP and poured into methanol to precipitate a white flaky polymer. The polymer was recovered and then dried under reduced pressure at room temperature.

The synthesized compound had yield amount: 1.163 g, yield ratio: 94%, logarithmic viscosity: 0.48 dL/g (30° C., 0.5 g/dL NMP solution), number average molecular weight (Mₙ) measured by GPC (THF) as described above: 38,000, weight average molecular weight (M_{w}): 65,000, molecular weight distribution (M_{w}/Mₙ): 1.7, average polymerization degree (n): 61.

The polymer was dissolved in TMU and a 15 wt % solution was prepared. This solution was cast on a glass plate, heated stepwise to 160° C. under reduced pressure, and dried under reduced pressure at 160° C. for 3 hours. The glass plate was immersed in distilled water and the film was peeled off and dried under reduced pressure at 200° C. for 3 hours to produce a colorless and transparent cast film (film thickness: 38 μm).

For this Example, the analysis results using the instruments described above were

FT-IR (film, cm⁻¹): 3062 (Ar—H), 2948 (C—H), 1593 (C═C), 1518 (C═N), 1504 (C═C), 1368 (C—N), 1242 (Ar—O)

¹H-NMR (CDCl₃, ppm): 8.68-8.50 (m, 6H), 7.52-7.48 (m, 3H), 7.36 (d, 2H), 7.23 (d, 2H), 7.05 (d, 4H), 7.00 (d, 2H), 6.94 (d, 2H), 2.71 (d, 1H), 2.47 (d, 1H), 2.04-2.01 (br, 1H), 1.96 (d, 1H), 1.41 (d, 1H), 1.20 (t, 1H), 1.00 (s, 6H), 0.89 (t, 1H), 0.43 (s, 3H)

Elemental analysis (C₄₂H₃₇N₃O₂)ₙ: Calculated values C, 81.92%; H, 6.06%; N, 6.82% Measured values C, 81.88%; H, 6.18%; N, 6.88%

Solubility: Soluble in N-methyl-2-pyrrolidone (NMP), tetramethyl urea (TMU), N,N′-dimethylimidazolidone (DMI), N,N′-dimethylpropylene urea (DMPU), cyclopentanone, cyclohexanone, tetrahydrofuran (THF), and chloroform

Glass transition temperature (T_{g}): 279° C. (DSC), 277° C. (DMA), 281° C. (TMA)

Coefficient of thermal expansion (CTE): 75 ppm/° C. (range from 150° C. to 200° C.)

5% weight loss temperature (T_{5%}): 480° C. (in air), 511° C. (in nitrogen)

10% weight loss temperature (T_{10%}): 496° C. (in air), 520° C. (in nitrogen)

Char yield (800° C. in nitrogen): 25%

Cutoff wavelength: 354 nm

Transmittance (500 nm): 81%

Average refractive index (nₐᵥₑ): 1.637 (d-line)

Birefringence (Δn): 0.006 (d-line)

Dielectric constant (ε=nₐᵥₑ²): 2.68

Dielectric constant (Dₖ): 2.64 (cavity resonator, TM mode, 10 GHz)

Dielectric constant (Dₖ): 2.57 (cavity resonator, TE mode, 10 GHz)

Dielectric loss tangent (D_{f}): 0.0018 (cavity resonator, TM mode, 10 GHz)

Dielectric loss tangent (D_{f}): 0.0014 (cavity resonator, TE mode, 10 GHz)

Tensile breaking strength: 73 MPa

Breaking elongation: 4.5%

Initial tensile modulus: 2.0 GPa.

### Example 4

The compound of Example 4, which was the polyether in the following formula (BFPT-BisPIND), was synthesized as follows.

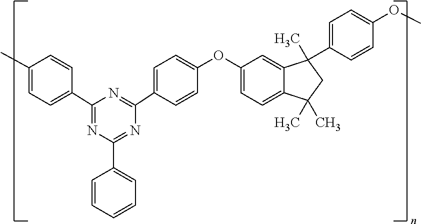

BFPT (0.6907 g, 2.00 mmol) and BisPIND (0.5368 g, 2.0) mmol) were placed into a two-necked flask (50 mL) provided with a stirrer and a nitrogen gas inlet tube and potassium carbonate (0.3334 g, 2.40 mmol) as an alkali metal compound, N-methyl-2-pyrrolidone (NMP, 5.0 mL) as a polar solvent, and toluene (20 mL) as an inert solvent component were added thereto. A Dean-Stark trap and a Liebig condenser were attached and a nitrogen gas atmosphere was created. The temperature was raised stepwise to 150° C. while stirring, toluene was refluxed at 150° C. for 2 hours, and water was removed using the Dean-Stark trap. Thereafter, the temperature was raised to 190° C. and the result was stirred for 1 hour to remove toluene. Thereafter, polymerization was carried out at 190° C. for 2 hours. The result was left to cool to room temperature to obtain a brown, viscous polymerization solution. The polymer was precipitated by being poured into methanol, recovered, and then washed with hot methanol and dried under reduced pressure at room temperature. The obtained polymer was dissolved in NMP and poured into methanol to precipitate a white flaky polymer. The polymer was recovered and then dried under reduced pressure at room temperature.

The synthesized compound had yield amount: 1.030 g, yield ratio: 90%, logarithmic viscosity: 0.96 dL/g (30° C., 0.5 g/dL NMP solution), number average molecular weight (Mₙ) measured by GPC (THF) as described above: 112,000, weight average molecular weight (M_{w}): 380,000, molecular weight distribution (M_{w}/Mₙ): 3.4, average polymerization degree (n): 195.

The polymer was dissolved in TMU and a 10 wt % solution was prepared. This solution was cast on a glass plate, heated stepwise to 160° C. under reduced pressure, and dried under reduced pressure at 160° C. for 3 hours. The glass plate was immersed in distilled water and the film was peeled off and dried under reduced pressure at 200° C. for 3 hours to produce a colorless and transparent cast film (film thickness: 43 μm).

For this Example, the analysis results using the instruments described above were

FT-IR (film, cm⁻¹): 3062 (Ar—H), 2958 (C—H), 1593 (C═C), 1518 (C═N), 1507 (C═C), 1368 (C—N), 1239 (Ar—O)

¹H-NMR (CDCl₃, ppm): 8.63-8.58 (m, 6H), 7.46-7.42 (m, 3H), 7.19-7.17 (m, 3H), 7.07-7.04 (m, 2H), 7.00-6.96 (m, 5H), 6.86 (s, 1H), 2.43 (d, 1H), 2.24 (d, 1H), 1.67 (s, 3H), 1.36 (s, 3H), 1.11 (s, 3H)

Elemental analysis (C₃₉H₃₁N₃O₂)ₙ: Calculated values C, 81.65%; H, 5.45%; N, 7.32% Measured values C, 81.41%; H, 5.56%; N, 7.23%

Solubility: Soluble in N-methyl-2-pyrrolidone (NMP), tetramethyl urea (TMU), N,N′-dimethylimidazolidone (DMI), N,N′-dimethylpropylene urea (DMPU), cyclopentanone, cyclohexanone, tetrahydrofuran (THF), and chloroform

Glass transition temperature (T_{g}): 266° C. (DSC), 265° C. (DMA), 286° C. (TMA)

Coefficient of thermal expansion (CTE): 78 ppm/° C. (range from 150° C. to 200° C.)

5% weight loss temperature (T_{5%}): 512° C. (in air), 513° C. (in nitrogen)

10% weight loss temperature (T_{10%}): 522° C. (in air), 520° C. (in nitrogen)

Char yield (800° C. in nitrogen): 30%

Cutoff wavelength: 352 nm

Transmittance (500 nm): 84%

Average refractive index (nₐᵥₑ): 1.653 (d-line)

Birefringence (Δn): 0.012 (d-line)

Dielectric constant (ε=nₐᵥₑ²): 2.73

Dielectric constant (Dₖ): 2.71 (cavity resonator, TM mode, 10 GHz)

Dielectric constant (Dₖ): 2.72 (cavity resonator, TE mode, 10 GHz)

Dielectric loss tangent (D_{f}): 0.0020 (cavity resonator, TM mode, 10 GHz)

Dielectric loss tangent (D_{f}): 0.0018 (cavity resonator, TE mode, 10 GHz)

Tensile breaking strength: 63 MPa

Breaking elongation: 3.6%

Initial tensile modulus: 1.9 GPa.

### Example 5

The compound of Example 5, which was the polyether (BFPT-BisC) in the following formula, was synthesized as follows.

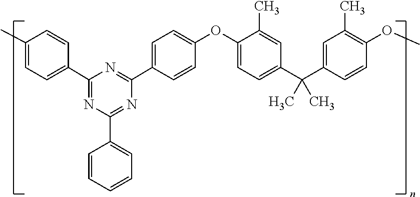

The BisA in Example 1 was changed to BisC to perform polymerization in NMP (5.0 mL) at 190° C. for 3 hours and polyether was synthesized in the same manner.

The synthesized compound had yield amount: 1.07 g, yield ratio: 95%, logarithmic viscosity: 0.67 dL/g (30° C., 0.5 g/dL NMP solution), number average molecular weight (Mₙ) measured by GPC (THF) as described above: 55,000, weight average molecular weight (M_{w}): 109,000, molecular weight distribution (M_{w}/Mₙ): 2.0, average polymerization degree (n): 97.

The polymer was dissolved in NMP, cast on a glass plate, heated stepwise to 160° C. under reduced pressure, and dried under reduced pressure at 160° C. for 3 hours. The glass plate was immersed in distilled water and the film was peeled off and dried under reduced pressure at 200° C. for 3 hours to produce a colorless and transparent cast film (film thickness: 47 μm).

For this Example, the analysis results using the instruments described above were

FT-IR (film, cm⁻¹): 3062 (Ar—H), 2968 (C—H), 1593 (C═C), 1518 (C═N), 1501 (C═C), 1368 (C—N), 1239 (Ar—O)

¹H-NMR (CDCl₃, ppm): 8.70-8.68 (m, 6H), 7.55-7.49 (m, 3H), 7.18 (br, 2H), 7.10 (d, 2H), 7.02 (d, 4H), 6.94 (d, 2H), 2.20 (s, 6H), 1.71 (s, 6H)

Elemental analysis (C₃₈H₃₁N₃O₂)ₙ: Calculated values C, 81.26%; H, 5.56%; N, 7.48% Measured values C, 81.67%; H, 5.72%; N, 7.50%

Solubility: Soluble in N-methyl-2-pyrrolidone (NMP), tetramethyl urea (TMU), N,N′-dimethylimidazolidone (DMI), cyclopentanone, cyclohexanone, tetrahydrofuran (THF), and chloroform

Glass transition temperature (T_{g}): 229° C. (DSC), 228° C. (DMA), 267° C. (TMA)

Coefficient of thermal expansion (CTE): 91 ppm/° C. (range from 150° C. to 200° C.)

5% weight loss temperature (T_{5%}): 450° C. (in air), 468° C. (in nitrogen)

10% weight loss temperature: (T_{10%}): 478° C. (in air), 472° C. (in nitrogen)

Carbonization yield ratio (800° C. in nitrogen): 28%

Cutoff wavelength: 352 nm

Transmittance (500 nm): 78%

Average refractive index (nₐᵥₑ): 1.663 (d-line)

Birefringence (Δn): 0.014 (d-line)

Dielectric constant (ε=ₙₐᵥₑ²): 2.77

Dielectric constant (Dₖ): 2.75 (cavity resonator, TM mode, 10 GHz)

Dielectric constant (Dₖ): 2.71 (cavity resonator, TE mode, 10 GHz)

Dielectric loss tangent (D_{f}): 0.0011 (cavity resonator, TM mode, 10 GHz)

Dielectric loss tangent (D_{f}): 0.0014) (cavity resonator, TE mode, 10 GHz)

Tensile breaking strength: 77 MPa

Breaking elongation: 11.2%

Initial tensile modulus: 2.0 GPa.

### Example 6

The compound of Example 6, which was the polyether (BFPT-TMBisA) in the following formula, was synthesized as follows.

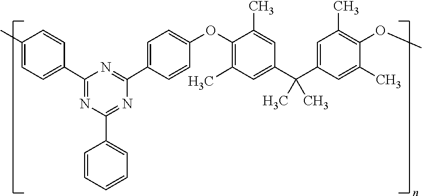

The BisA in Example 1 was changed to TMBisA to perform polymerization in NMP (5 mL) at 200° C. for 3 hours and polyether was synthesized in the same manner.

The synthesized compound had yield amount: 1.12 g, yield ratio: 95%, logarithmic viscosity: 0.43 dL/g (30° C., 0.5 g/dL NMP solution), number average molecular weight (Mₙ) measured by GPC (THF) as described above: 43,000, weight average molecular weight (M_{w}): 77,000, molecular weight distribution (M_{w}/Mₙ): 1.8, average polymerization degree (n): 72.

The polymer was dissolved in NMP, cast on a glass plate, heated stepwise to 160° C. under reduced pressure, and dried under reduced pressure at 160° C. for 3 hours. The glass plate was immersed in distilled water and the film was peeled off and dried under reduced pressure at 200° C. for 3 hours to produce a colorless and transparent cast film (film thickness: 63 μm).

For this Example, the analysis results using the instruments described above were

FT-IR (film, cm⁻¹): 3064 (Ar—H), 2968 (C—H), 1606 (C═C), 1521 (C═N), 1510 (C═C), 1368 (C—N), 1235 (Ar—O)

Elemental analysis (C₄₀H₃₅N₃O₂)ₙ: Calculated values C, 81.46%; H, 5.98%; N, 7.13% Measured values C, 81.54%; H, 6.10%; N, 7.02%

Solubility: Soluble in N-methyl-2-pyrrolidone (NMP), tetramethyl urea (TMU), N,N′-dimethylimidazolidone (DMI), cyclopentanone, cyclohexanone, tetrahydrofuran (THF), and chloroform

Glass transition temperature (T_{g}): 286° C. (DSC), 285° C. (DMA), 308° C. (TMA)

Coefficient of thermal expansion (CTE): 74 ppm/° C. (range from 150° C. to 200° C.)

5% weight loss temperature (T_{5%}): 419° C. (in air), 450° C. (in nitrogen)

10% weight loss temperature (T_{10%}): 442° C. (in air), 453° C. (in nitrogen)

Char yield (800° C. in nitrogen): 22%

Cutoff wavelength: 348 nm

Transmittance (500 nm): 78%

Average refractive index (nₐᵥₑ): 1.634 (d-line)

Birefringence (Δn): 0.017 (d-line)

Dielectric constant (ε=ₙₐᵥₑ²): 2.67

Dielectric constant (Dₖ): 2.66 (cavity resonator, TM mode, 10 GHz)

Dielectric constant (Dₖ): 2.62 (cavity resonator, TE mode, 10 GHz)

Dielectric loss tangent (D_{f}): 0.0014 (cavity resonator, TM mode, 10 GHz)

Dielectric loss tangent (D_{f}): 0.0016 (cavity resonator, TE mode, 10 GHz)

Tensile breaking strength: 61 MPa

Breaking elongation: 3.5%

Initial tensile modulus: 2.0 GPa.

### Example 7

The compound of Example 7, which was the polyether (BFPT-BisCHP) in the following formula, was synthesized as follows.

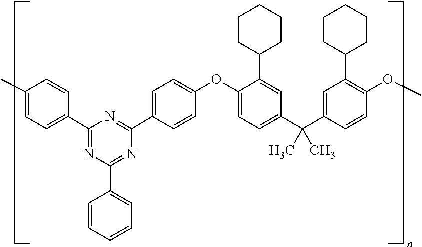

The BisA in Example 1 was changed to BisCHP to perform polymerization in NMP (5 mL) at 190° C. for 3 hours and polyether was synthesized in the same manner.

The synthesized compound had yield amount: 1.33 g, yield ratio: 95%, logarithmic viscosity: 0.57 dL/g (30° C., 0.5 g/dL NMP solution), number average molecular weight (Mₙ) measured by GPC (THF) as described above: 56,000, weight average molecular weight (M_{w}): 119,000, molecular weight distribution (M_{w}/Mₙ): 2.1, average polymerization degree (n): 80.

The polymer was dissolved in NMP, cast on a glass plate, heated stepwise to 160° C. under reduced pressure, and dried under reduced pressure at 160° C. for 3 hours. The glass plate was immersed in distilled water and the film was peeled off and dried under reduced pressure at 200° C. for 3 hours to produce a colorless and transparent cast film (film thickness: 53 μm).

For this Example, the analysis results using the instruments described above were

FT-IR (film, cm⁻¹): 3066 (Ar—H), 2926 (C—H), 1588 (C═C), 1521 (C═N), 1519 (C═C), 1368 (C—N), 1234 (Ar—O)

Elemental analysis (C₄₈H₄₇N₃O₂)ₙ: Calculated values C, 82.60%; H, 6.79%; N, 6.02%; Measured values C, 82.67%; H, 6.85%; N, 6.03%

Solubility: Soluble in N-methyl-2-pyrrolidone (NMP), tetramethyl urea (TMU), cyclopentanone, cyclohexanone, tetrahydrofuran (THF), and chloroform

Glass transition temperature (T_{g}): 221° C. (DSC), 221° C. (DMA), 222° C. (TMA)

Coefficient of thermal expansion (CTE): 95 ppm/° C. (range from 150° C. to 200° C.)

5% weight loss temperature (T_{5%}): 455° C. (in air), 469° C. (in nitrogen)

10% weight loss temperature (T_{10%}): 465° C. (in air), 472° C. (in nitrogen)

Char yield (800° C. in nitrogen): 9%

Cutoff wavelength: 350 nm

Transmittance (500 nm): 80%

Average refractive index (nₐᵥₑ): 1.630 (d-line)

Birefringence (Δn): 0.007 (d-line)

Dielectric constant (ε=nₐᵥₑ²): 2.66

Dielectric constant (Dₖ): 2.62 (cavity resonator, TM mode, 10 GHz)

Dielectric constant (Dₖ): 2.64 (cavity resonator, TE mode, 10 GHz)

Dielectric loss tangent (D_{f}): 0.0008 (cavity resonator, TM mode, 10 GHz)

Dielectric loss tangent (D_{f}): 0.0009 (cavity resonator, TE mode, 10 GHz)

Tensile breaking strength: 75 MPa

Breaking elongation: 4.1%

Initial tensile modulus: 2.3 GPa.

### Example 8

The compound of Example 8, which was the polyether [BFPT-BisZ/BisAF (25 mol %/75 mol %)] in the following formula, was synthesized as follows.

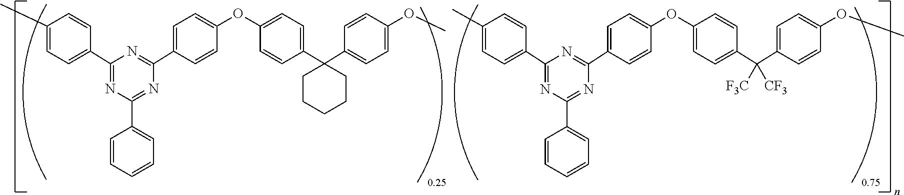

The BisA in Example 1 was changed to BisZ (25 mol %) and BisAF (75 mol %) to perform polymerization in NMP (5 mL) at 190° C. for 3 hours and polyether was synthesized in the same manner.

Yield ratio: 94%, logarithmic viscosity: 1.06 dL/g (30° C., 0.5 g/dL NMP solution), number average molecular weight (Mₙ) measured by GPC (THF) described above: 80,000, weight average molecular weight (M_{w}): 192,000, molecular weight distribution (M_{w}/Mₙ): 2.4, average polymerization degree (n): 128.

The polymer was dissolved in NMP, cast on a glass plate, heated stepwise to 160° C. under reduced pressure, and dried under reduced pressure at 160° C. for 3 hours. The glass plate was immersed in distilled water and the film was peeled off and dried under reduced pressure at 200° C. for 3 hours to produce a colorless and transparent cast film (film thickness: 84 μm).

For this Example, the analysis results using the instruments described above were

FT-IR (film, cm⁻¹): 3068 (Ar—H), 2936 (C—H), 1596 (C═C), 1521 (C═N), 1502 (C═C), 1368 (C—N), 1246 (Ar—O)

Elemental analysis (C_{36.75}H_{23.5}N₃O₂F_{4.5})ₙ: Calculated values C, 70.67%; H, 3.79%; N, 6.73% Measured values C, 71.08%; H, 3.97%; N, 6.67%

Solubility: soluble in N-methyl-2-pyrrolidone (NMP), tetramethyl urea (TMU), N,N′-dimethylimidazolidone (DMI), N,N′-dimethylpropylene urea (DMPU), cyclopentanone, cyclohexanone, tetrahydrofuran (THF), and chloroform

Glass transition temperature (Tg): 250° C. (DSC), 248° C. (DMA)

Coefficient of thermal expansion (CTE): 83 ppm/° C. (range from 150° C. to 200° C.)

5% weight loss temperature (T_{5%}): 517° C. (in air), 514° C. (in nitrogen)

10% weight loss temperature (T_{10%}): 536° C. (in air), 528° C. (in nitrogen)

Char yield (800° C. in nitrogen): 59%

Cutoff wavelength: 351 nm

Transmittance (500 nm): 79%

Average refractive index (nₐᵥₑ): 1.634 (d-line)

Birefringence (Δn): 0.022 (d-line)

Dielectric constant (ε=nₐᵥₑ²): 2.67

Dielectric constant (Dₖ): 2.77 (cavity resonator, TM mode, 10 GHz)

Dielectric constant (Dₖ): 2.76 (cavity resonator, TE mode, 10 GHz)

Dielectric loss tangent (D_{f}) 0.0017 (cavity resonator, TM mode, 10 GHz)

Dielectric loss tangent (D_{f}): 0.0016 (cavity resonator, TE mode, 10 GHz)

Tensile breaking strength: 73 MPa

Breaking elongation: 5.6%

Initial tensile modulus: 2.1 GPa.

### Example 9

The compound of Example 9, which was the polyether [BFPT-BisP3MZ/BisAF (50 mol %/50 mol %)] in the following formula, was synthesized as follows.

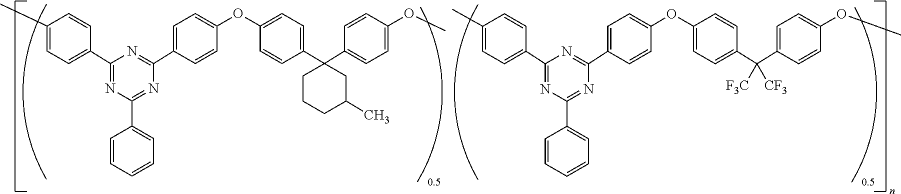

The BisA in Example 1 was changed to BisP3MZ (50 mol %) and BisAF (50 mol %) to perform polymerization in NMP (5 mL) at 190° C. for 3 hours and polyether was synthesized in the same manner.

The synthesized compound had yield amount: 1.030 g, yield ratio: 84%, logarithmic viscosity: 0.81 dL/g (30° C., 0.5 g/dL NMP solution), number average molecular weight (Mₙ) measured by GPC (THF) as described above: 47,000, weight average molecular weight (M_{w}): 110,000, molecular weight distribution (M_{w}/Mₙ): 2.1, average polymerization degree (n): 76.

The polymer was dissolved in NMP, cast on a glass plate, heated stepwise to 160° C. under reduced pressure, and dried under reduced pressure at 160° C. for 3 hours. The glass plate was immersed in distilled water and the film was peeled off dried under reduced pressure at 200° C. for 3 hours to produce a colorless and transparent cast film (film thickness: 58 μm).

For this Example, the analysis results using the instruments described above were

FT-IR (film, cm⁻¹): 3064 (Ar—H), 2929 (C—H), 1594 (C═C), 1518 (C═N), 1506 (C═C), 1368 (C—N), 1246 (Ar—O)

Elemental analysis (C₃₈H₂₇N₃O₂F₃)ₙ: Calculated values C, 74.25%; H, 4.43%; N, 6.84% Measured values C, 74.34%; H, 4.57%; N, 6.83%

Solubility: soluble in N-methyl-2-pyrrolidone (NMP), tetramethyl urea (TMU), N,N′-dimethylimidazolidone (DMI), N,N′-dimethylpropylene urea (DMPU), cyclopentanone, cyclohexanone, tetrahydrofuran (THF), and chloroform

Glass transition temperature (T_{g}): 260° C. (DSC), 259° C. (DMA)

Coefficient of thermal expansion (CTE): 78 ppm/° C. (range from 150° C. to 200° C.)

5% weight loss temperature (T_{5%}): 499° C. (in air), 510° C. (in nitrogen)

10% weight loss temperature (T_{10%}): 527° C. (in air), 520° C. (in nitrogen)

Char yield (800° C. in nitrogen): 48%

Cutoff wavelength: 350 nm

Transmittance (500 nm): 78%

Average refractive index (nₐᵥₑ): 1.639 (d-line)

Birefringence (Δn): 0.021 (d-line)

Dielectric constant (ε=nₐᵥₑ²): 2.69

Dielectric constant (Dₖ): 2.75 (cavity resonator, TM mode, 10 GHz)

Dielectric constant (Dₖ): 2.73 (cavity resonator, TE mode, 10 GHz)

Dielectric loss tangent (D_{f}): 0.0019 (cavity resonator, TM mode, 10 GHz)

Dielectric loss tangent (D_{f}) 0.0020 (cavity resonator, TE mode, 10 GHz)

Tensile breaking strength: 64 MPa

Breaking elongation: 19.4%

Initial tensile modulus: 2.0 GPa.

### Example 10

The compound of Example 10, which was the polyether (BFPT-BisP-CDE) in the following formula, was synthesized as follows.

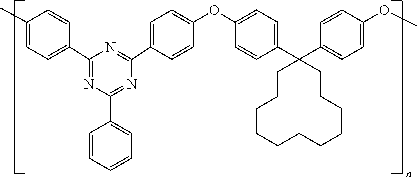

The BisA in Example 1 was changed to BisP CDE to perform polymerization in NMP (5 mL) at 190° C. for 3 hours and polyether was synthesized in the same manner.

Yield ratio: 96%, logarithmic viscosity: 0.51 dL/g (30° C., 0.5 g/dL DMPU solution).

The polymer was dissolved in DMPU, cast on a glass plate, heated stepwise to 160° C. under reduced pressure, and dried under reduced pressure at 160° C. for 3 hours. The glass plate was immersed in distilled water and the film was peeled off and dried under reduced pressure at 200° C. for 3 hours to produce a colorless and transparent cast film (film thickness: 76 μm).

For this Example, the analysis results using the instruments described above were

FT-IR (film, cm⁻¹): 3064 (Ar—H), 2937 (C—H), 1592 (C═C), 1521 (C═N), 1501 (C═C), 1368 (C—N), 1242 (Ar—O)

Elemental analysis (C₄₅H₄₃N₃O₂)ₙ: Calculated values C, 82.16%; H, 6.59%; N, 6.39% Measured values C, 82.25%; H, 6.65%; N, 6.32%

Solubility: Soluble in N,N′-dimethylpropylene urea (DMPU)

Glass transition temperature (T_{g}): 272° C. (DSC), 272° C. (DMA)

Coefficient of thermal expansion (CTE): 83 ppm/° C. (range from 150° C. to 200° C.)

5% weight loss temperature (T_{5%}): 400° C. (in air), 443° C. (in nitrogen)

10% weight loss temperature (T_{10%}): 443° C. (in air), 458° C. (in nitrogen)

Char yield (800° C. in nitrogen): 30%

Cutoff wavelength: 350 nm

Average refractive index (nₐᵥₑ): 1.638 (d-line)

Birefringence (Δn): 0.019 (d-line)

Dielectric constant (ε=nₐᵥₑ²): 2.68

Dielectric constant (Dₖ): 2.67 (cavity resonator, TM mode, 10 GHz)

Dielectric constant (Dₖ): 2.66 (cavity resonator, TE mode, 10 GHz)

Dielectric loss tangent (D_{f}): 0.0020 (cavity resonator, TM mode, 10 GHz)

Dielectric loss tangent (D_{f}): 0.0017 (cavity resonator, TE mode, 10 GHz)

Tensile breaking strength: 54 MPa

Breaking elongation: 5.1%

Initial tensile modulus: 1.6 GPa.

### Example 11

The compound of Example 11, which was the polyether (BFPT-DTPM) in the following formula, was synthesized as follows.

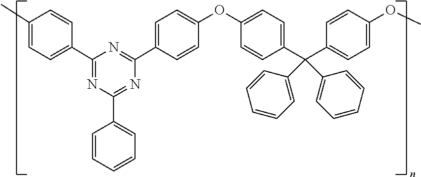

The BisA in Example 1 was changed to DTPM to perform polymerization in NMP (5.0 mL) at 190° C. for 3 hours and polyether was synthesized in the same manner.

Yield ratio: 93%, logarithmic viscosity: 0.69 dL/g (30° C., 0.5 g/dL NMP solution), number average molecular weight (Mₙ) measured by GPC (THF) described above: 63,000, weight average molecular weight (M_{w}): 199,000, molecular weight distribution (M_{w}/Mₙ): 3.2, average polymerization degree (n): 95.

The polymer was dissolved in NMP, cast on a glass plate, heated stepwise to 160° C. under reduced pressure, and dried under reduced pressure at 160° C. for 3 hours. The glass plate was immersed in distilled water and the film was peeled off and dried under reduced pressure at 200° C. for 3 hours to produce a colorless and transparent cast film (film thickness: 70 μm).

For this Example, the analysis results using the instruments described above were

FT-IR (film, cm⁻¹): 3059 (Ar—H), 1592 (C═C), 1521 (C═N), 1499 (C═C), 1369 (CN), 1241 (Ar—O)

¹H-NMR (CDCl₃, ppm): 8.68-8.64 (m, 6H), 7.52-7.48 (m, 3H), 7.29-7.20 (m, 14H), 7.12 (d, 4H), 6.98 (d, 4H)

Elemental analysis (C₄₆H₃₁N₃O₂)ₙ: Calculated values C, 83.99%; H, 4.75%; N, 6.39% Measured values C, 84.07%; H, 4.85%; N, 6.32%

Solubility: Soluble in N-methyl-2-pyrrolidone (NMP), tetramethyl urea (TMU), N,N′-dimethylimidazolidone (DMI), cyclopentanone, tetrahydrofuran (THF), and chloroform

Glass transition temperature (T_{g}): 263° C. (DSC), 266° C. (DMA)

Coefficient of thermal expansion (CTE): 97 ppm/° C. (range from 150° C. to 200° C.)

5% weight loss temperature (T_{5%}): 546° C. (in air), 543° C. (in nitrogen)

10% weight loss temperature (T_{10%}): 558° C. (in air), 552° C. (in nitrogen)

Char yield (800° C. in nitrogen): 53%

Cutoff wavelength: 352 nm

Transmittance (500 nm): 68%

Average refractive index (nₐᵥₑ): 1.682 (d-line)

Birefringence (Δn): 0.017 (d-line)

Dielectric constant (ε=nₐᵥₑ²): 2.83

Dielectric constant (Dₖ): 2.82 (cavity resonator, TM mode, 10 GHz)

Dielectric constant (Dₖ): 2.82 (cavity resonator, TE mode, 10 GHz)

Dielectric loss tangent (D_{f}): 0.0018 (cavity resonator, TM mode, 10 GHz)

Dielectric loss tangent (D_{f}): 0.0017 (cavity resonator, TE mode, 10 GHz)

Tensile breaking strength: 70 MPa

Breaking elongation: 3.2%

Initial tensile modulus: 1.6 GPa.

### Example 12

The compound of Example 12, which was the polyether (BFPT-BPFL) in the following formula, was synthesized as follows.

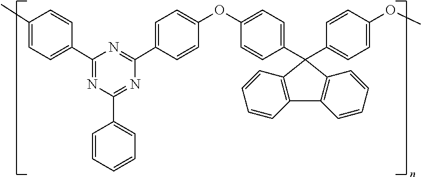

BFPT (0.6340 g, 1.84 mmol) and BPFL (0.6433 g, 1.84 mmol) were placed into a two-necked flask (50 mL) provided with a stirrer and a nitrogen gas inlet tube and potassium carbonate (0.3060 g, 2.20 mmol) as an alkali metal compound, N-methyl-2-pyrrolidone (NMP, 5.0 mL) as a polar solvent, and toluene (20 mL) as an inert solvent component were added thereto. A Dean-Stark trap and a Liebig condenser were attached and a nitrogen gas atmosphere was created. The temperature was raised stepwise to 150° C. while stirring, toluene was refluxed at 150° C. for 2 hours, and the produced water was removed using the Dean-Stark trap. Thereafter, the temperature was raised to 190° C. and the result was stirred for 1 hour to remove toluene. Thereafter, polymerization was carried out at 190° C. for 2 hours. The result was left to cool to room temperature to obtain a viscous polymerization solution. The polymer was precipitated by being poured into methanol, recovered, and then washed with hot methanol and dried under reduced pressure at room temperature. The obtained polymer was dissolved in NMP and poured into methanol to precipitate a white flaky polymer. The polymer was recovered and then dried under reduced pressure at room temperature.

This compound had yield amount: 1.134 g, yield ratio: 94%, logarithmic viscosity: 0.88 dL/g (30° C. 0.5 g/dL of NMP solution), number average molecular weight (Mₙ) measured by GPC (THF) described above: 77,000, weight average molecular weight (M_{w}): 206,000, molecular weight distribution (M_{w}/Mₙ): 2.7, average polymerization degree (n): 117.

This polymer was dissolved in TMU and a 12 wt % solution was prepared. This solution was cast on a glass plate, heated stepwise to 160° C. under reduced pressure, and dried under reduced pressure at 160° C. for 3 hours. The glass plate was immersed in distilled water and the film was peeled off and dried under reduced pressure at 200° C. for 3 hours to produce a colorless and transparent cast film (film thickness: 64 μm).

For this Example, the analysis results using the instruments described above were

FT-IR (film, cm⁻¹): 3062 (Ar—H), 1592 (C═C), 1519 (C═N), 1502 (C═C), 1368 (CN), 1241 (Ar—O)

¹H-NMR (CDCl₃, ppm): 8.65-8.64 (m, 6H), 7.75 (d, 2H), 7.52-7.48 (m, 3H), 7.42 (d, 2H), 7.35 (t, 2H), 7.28 (t, 2H), 7.17 (d, 4H), 7.07 (d, 4H), 6.93 (d, 4H)

Elemental analysis (C₄₆H₂₉N₃O₂)ₙ: Calculated values C, 84.25%; H, 4.46%; N, 6.41%; Measured values C, 84.18%; H, 4.51%; N, 6.43%

Solubility: Soluble in N-methyl-2-pyrrolidone (NMP), tetramethyl urea (TMU), N,N′-dimethylimidazolidone (DMI), chloroform, tetrahydrofuran (THF), cyclopentanone, and cyclohexanone.

Glass transition temperature (T_{g}): 309° C. (DSC), 306° C. (DMA)

Coefficient of thermal expansion (CTE): 96 ppm/° C. (range from 150° C. to 200° C.)

5% weight loss temperature: 516° C. (in air), 568° C. (in nitrogen)

10% weight loss temperature: 525° C. (in air), 578° C. (in nitrogen)

Char yield: 58% (800° C. in nitrogen)

Cutoff wavelength: 353 nm

Transmittance at 500 nm: 82%

Average refractive index (nₐᵥₑ): 1.689 (d-line)

Birefringence (Δn): 0.003 (d-line)

Dielectric constant (ε=nₐᵥₑ²): 2.85

Dielectric constant (Dₖ): 2.82 (cavity resonator, TM mode, 10 GHz)

Dielectric constant (Dₖ): 2.78 (cavity resonator, TE mode, 10 GHz)

Dielectric loss tangent (D_{f}): 0.0016 (cavity resonator, TM mode, 10 GHz)

Dielectric loss tangent (D_{f}): 0.0017 (cavity resonator, TE mode, 10 GHz)

Tensile breaking strength: 81 MPa

Breaking elongation: 4.4%

Tensile initial elastic modulus: 2.2G.

### Example 13

The compound of Example 13, which was the polyether (BFPT-DMBPFL) in the following formula, was synthesized as follows.

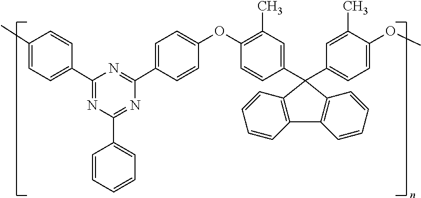

The BisA in Example 1 was changed to DMBPFL to perform polymerization in NMP (5.0 mL) at 190° C. for 3 hours and polyether was synthesized in the same manner.

Yield ratio: 95%, logarithmic viscosity: 0.91 dL/g (30° C. 0.5 g/dL NMP solution), number average molecular weight (Mₙ) measured by GPC (THF) described above: 87,000, weight average molecular weight (M_{w}): 249,000, molecular weight distribution (M_{w}/Mₙ): 2.9, average polymerization degree (n): 127.

The polymer was dissolved in NMP, cast on a glass plate, heated stepwise to 160° C. under reduced pressure, and dried under reduced pressure at 160° C. for 3 hours. The glass plate was immersed in distilled water and the film was peeled off and dried under reduced pressure at 200° C. for 3 hours to produce a colorless and transparent cast film (film thickness: 79 μm).

For this Example, the analysis results using the instruments described above were

FT-IR (film, cm⁻¹): 3064 (Ar—H), 2921 (C—H), 1588 (C═C), 1521 (C═N), 1509 (C═C), 1369 (C—N), 1248 (Ar—O)

¹H-NMR (CDCl₃, ppm): 8.68-8.64 (m, 6H), 7.79 (d, 2H), 7.54-7.47 (m, 5H), 7.39 (t, 2H), 7.32 (t, 2H), 7.11-7.09 (m, 4H), 6.99 (d, 4H), 6.89 (d, 2H), 2.11 (s, 6H)

Elemental analysis (C₄₈H₃₃N₃O₂)ₙ: Calculated values C, 84.31%; H, 4.87%; N, 6.15%; Measured values C, 84.40%; H, 4.98%; N, 6.12%

Solubility: Soluble in N-methyl-2-pyrrolidone (NMP), tetramethyl urea (TMU), N,N′-dimethylimidazolidone (DMI), cyclopentanone, cyclohexanone, tetrahydrofuran (THF), and chloroform

Glass transition temperature (T_{g}): 298° C. (DSC), 297° C. (DMA)

Coefficient of thermal expansion (CTE): 86 ppm/° C. (range from 150° C. to 200° C.)

5% weight loss temperature (T_{5%}): 474° C. (in air), 450° C. (in nitrogen)

10% weight loss temperature (T_{10%}): 522° C. (in air), 457° C. (in nitrogen)

Char yield (800° C. in nitrogen): 56%

Cutoff wavelength: 354 nm

Transmittance (500 nm): 75%

Average refractive index (nₐᵥₑ): 1.678 (d-line)

Birefringence (Δn): 0.012 (d-line)

Dielectric constant (ε=nₐᵥₑ²): 2.82

Dielectric constant (Dₖ): 2.78 (cavity resonator, TM mode, 10 GHz)

Dielectric constant (Dₖ): 2.81 (cavity resonator, TE mode, 10 GHz)

Dielectric loss tangent (D_{f}): 0.0019 (cavity resonator, TM mode, 10 GHz)

Dielectric loss tangent (D_{f}): 0.0017 (cavity resonator, TE mode, 10 GHz)

Tensile breaking strength: 73 MPa

Breaking elongation: 4.5%

Initial tensile modulus: 2.3 GPa.

### Example 14

The compound of Example 14, which was the polyether (BFPT-TBISRX) in the following formula, was synthesized as follows.

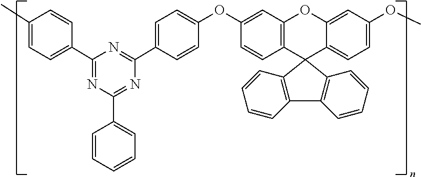

The BisA in Example 1 was changed to TBISRX to perform polymerization in NMP (5.0 mL) at 190° C. for 3 hours and polyether was synthesized in the same manner.

Yield ratio: 94%, logarithmic viscosity: 0.68 dL/g (30° C., 0.5 g/dL NMP solution), number average molecular weight (Mₙ) measured by GPC (NMP) as described above: 67,000, weight average molecular weight (M_{w}): 253,000, molecular weight distribution (M_{w}/Mₙ): 3.8, average polymerization degree (n): 100.

The polymer was dissolved in NMP, cast on a glass plate, heated stepwise to 160° C. under reduced pressure, and dried under reduced pressure at 160° C. for 3 hours. The glass plate was immersed in distilled water and the film was peeled off and dried under reduced pressure at 200° C. for 3 hours to produce a colorless and transparent cast film (film thickness: 85 μm).

For this Example, the analysis results using the instruments described above were

FT-IR (film, cm⁻¹): 3065 (Ar—H), 1595 (C═C), 1521 (C═N), 1486 (C═C), 1369 (CN), 1220 (Ar—O)

Solubility: soluble in N-methyl-2-pyrrolidone (NMP), tetramethyl urea (TMU), and N,N′-dimethylimidazolidone (DMI)

Glass transition temperature (T_{g}): 336° C. (DSC), 335° C. (DMA)

Coefficient of thermal expansion (CTE): 61 ppm/° C. (range from 150° C. to 200° C.)

5% weight loss temperature (T_{5%}): 579° C. (in air), 586° C. (in nitrogen)

10% weight loss temperature (T_{10%}): 597° C. (in air), 596° C. (in nitrogen)

Char yield (800° C. in nitrogen): 68%

Cutoff wavelength: 351 nm

Transmittance (500 nm): 72%

Average refractive index (nₐᵥₑ): 1.689 (d-line)

Birefringence (Δn): 0.015 (d-line)

Dielectric constant (ε=nₐᵥₑ²): 2.85

Dielectric constant (Dₖ): 2.81 (cavity resonator, TM mode, 10 GHz)

Dielectric constant (Dₖ): 2.81 (cavity resonator, TE mode, 10 GHz)

Dielectric loss tangent (D_{f}): 0.0020 (cavity resonator, TM mode, 10 GHz)

Dielectric loss tangent (D_{f}): 0.0019 (cavity resonator, TE mode, 10 GHz)

Tensile breaking strength: 78 MPa

Breaking elongation: 7.0%

Initial tensile modulus: 2.4 GPa.

### REFERENCE TEST EXAMPLES

Reference tests using Reference Examples are shown below as another aspect of the present embodiment.

### (Test Conditions)

The following instruments and reagents were used to synthesize the samples and analyze the synthesized samples.

The instruments and conditions used are as follows.
(1) GPC: High-speed GPC system HLC-8220GPC manufactured by Tosoh Corp., (column: Tosoh TSKgel (α-M), column temperature: 45° C., eluent: N-methyl-2-pyrrolidone (NMP) (including 0.01 mol/L lithium bromide), calibration curve: standard polystyrene, column flow rate: 0.2 mL/min)
(2) Infrared spectrum (FT-IR): FT/IR-4200 manufactured by JASCO Corp.
(3) Nuclear magnetic resonance spectrum (NMR): BRUKER AC400P
(4) Thermogravimetric analysis (TGA): TG/DTA7300 manufactured by Hitachi High-Tech Science Co., Ltd., heating rate 10° C./min
(5) Differential scanning calorimetry measurement (DSC): DSC7000 manufactured by Hitachi High-Tech Science Co., Ltd., heating rate 20° C./min
(6) Thermomechanical analysis (TMA): TMA7000 manufactured by Hitachi High-Tech Science Co., Ltd., heating rate 10° C./min
(7) Dynamic mechanical analysis (DMA): DMA7100 manufactured by Hitachi High-Tech Science Co., Ltd., heating rate 2° C./min
(8) Tensile test: Autograph AGS-D type manufactured by Shimadzu Corp., tensile speed 10 mm/min
(9) Ultraviolet-visible spectrophotometer: UV-1800 manufactured by Shimadzu Corp.
(10) Refractive index measurement: Model 2010/M PRISM COUPLER manufactured by Metricon
(11) Dielectric constant measurement: Dielectric constant/dielectric loss tangent measurement apparatus (cavity resonator-type) manufactured by AET Inc., TE mode (10 GHz, 20 GHz)

Commercially available reagents were used and purification was carried out by standard methods as necessary. Various reaction solvents were dried and purified by standard methods as necessary.

### (Production of Resin Composition)

Among the compounds of Formula (1), R=hydrogen (H) (BFPT) and Ar is adjusted to be each of
the BisA compound of Formula (2) (BFPT-BisA, Reference Example 1),
the BisAF compound of Formula (3) (BFPT-BisAF, Reference Example 2)
the BisP-HTG compound of Formula (4) (BFPT-PisP-HTG, Reference Example 3), and
the BisP-IND compound of Formula (5) (BFPT-BisP IND, Reference Example 4).

In addition, among the compounds of Formula (1), a compound in which R=hydrogen (H) (BFPT) and Ar=BPFL (9,9-bis(4-hydroxyphenyl)fluorene) was also adjusted (BFPT-BPFL, Reference Example 5).

As the compounds of Formula (6) and Formula (7) used in the production, a compound (BFPT) in which R=hydrogen (H) was used as the compound of Formula (6). As the compound of Formula (7), for each Reference Example, compounds in which Ar was Formula (2) (Reference Example 1), Formula (3) (Reference Example 2), Formula (4) (Reference Example 3), and Formula (5) (Reference Example 4) were used.

### Synthesis of Each Reference Example

### (BFPT Compound)

2,4-bis(4-fluorophenyl)-6-phenyl-1,3,5-triazine (BFPT) used in each Reference Example was synthesized as follows.

4-Fluorobenzamidine hydrochloride (7.460 g, 42.73 mmol), benzylideneaniline (3.625 g, 20.00 mmol), sodium hydrogen carbonate (3.781 g, 45.00 mmol), and N,N-dimethylformamide (DMF, 35 mL) were placed into a three-necked flask (100 mL) provided with a stirrer and a nitrogen gas inlet tube, the temperature was raised stepwise to 85° C., and a reaction was carried out at 85° C. for 96 hours. Thereafter, the result was cooled to room temperature. The reaction solution was introduced into distilled water and chloroform was added thereto. The chloroform solution was washed three times with distilled water using a separating funnel. When the recovered chloroform solution was dried over anhydrous sodium sulfate overnight and the anhydrous sodium sulfate was removed by suction filtration and then the chloroform solution was thickened by an evaporator and introduced into methanol (500 mL), a crude product was precipitated. When the result was recovered by suction filtration, washed with methanol under reflux, and dried under reduced pressure at room temperature, a crude product of brown needle crystals (1.61 g, 23.3%) was obtained. The crude product was recrystallized using a mixed solvent of chloroform and methanol and dried under reduced pressure at 80° C. for 24 hours.

The synthesized compound had a shape: white needle crystals, yield amount: 1.46 g, yield ratio: 21.1%, melting point: 259° C. to 262° C.

Regarding this BFPT, the analysis results using the instruments described above were

FT-IR (KBr, cm⁻¹): 3051 (Ar—H), 1603 (C═C), 1522 (C═N), 1508 (C═C), 1370 (CN), 1228 (Ar—F)

¹H-NMR (CDCl₃, ppm): 8.80-8.73 (m, 6H), 7.62 (t, 1H), 7.57 (t, 2H), 7.27-7.23 (m, 4H).

¹³C-NMR (CDCl₃, ppm): 171.74, 170.75, 165.93, 136.06, 132.78, 132.36, 131.39, 128.91, 115.84

¹⁹F-NMR (CDCl₃, ppm): 108.41

Elemental analysis (C₂₁H₁₃F₂N₃): Calculated values C, 73.03%; H, 3.79%; N, 12.17% Measured values C, 72.94%; H, 4.00%; N, 12.15%.

### Reference Example 1

The compound of Reference Example 1, which was polyether (BFPT-BisA), was synthesized as follows.

BFPT (0.6907 g, 2.00 mmol) and bisphenol A (0.4566 g, 2.00 mmol) were placed into a two-necked flask (50 mL) provided with a stirrer and a nitrogen gas inlet tube and potassium carbonate (0.3334 g, 2.40 mmol) as an alkali metal compound, N,N′-dimethylimidazolidone (DMI, 6.5 mL) as a neutral polar solvent, and toluene (20 mL) as an inert solvent component were added thereto. A Dean-Stark trap and a Liebig condenser were attached and a nitrogen gas atmosphere was created. The temperature was raised stepwise to 150° C. while stirring, toluene was refluxed at 150° C. for 2 hours, and the produced water was removed using the Dean-Stark trap. Thereafter, the temperature was raised to 190° C. and the result was stirred for 2 hours to remove toluene. Thereafter, polymerization was carried out at 190° C. for 2 hours. The result was left to cool to room temperature to obtain a brown, viscous polymerization solution. The polymer was precipitated by being poured into methanol, recovered, and then washed with hot methanol and dried under reduced pressure at room temperature. The obtained polymer was dissolved in N-methyl-2-pyrrolidone (NMP) and poured into methanol to precipitate a white flaky polymer. The polymer was recovered and then dried under reduced pressure at room temperature.

As shown in BFPT-BisA DMI in the table below, yield amount: 0.618 g, yield ratio: 58%, logarithmic viscosity: 0.54 dL/g (30° C., 0.5 g/dL NMP solution), number average molecular weight (Mₙ) measured using GPC as described above: 30,000, weight average molecular weight (M_{w}): 62,000, and molecular weight distribution (M_{w}/Mₙ): 2.1.

This polymer was dissolved in NMP and a 12 wt % solution was prepared. This solution was cast on a glass plate, heated stepwise to 200° C. under reduced pressure, and dried under reduced pressure at 200° C. for 3 hours to produce a colorless and transparent cast film (film thickness: 38 μm).

For this reference example, the analysis results using the instruments described above were

FT-IR (film, cm⁻¹): 3066 (Ar—H), 2968 (C—H), 1592 (C═C), 1517 (C═N), 1504 (C═C), 1368 (C—N), 1241 (Ar—O).

¹H-NMR (CDCl₃, ppm): 8.68 (d, 6H), 7.53-7.50 (m, 3H), 7.24 (d, 4H), 7.09 (d, 4H), 7.00 (d, 4H), 1.69 (s, 6H).

Cutoff wavelength: 353 nm, transmittance at 500 nm: 81%.

### Reference Example 2

The compound of Reference Example 2, which was polyether (BFPT-BisAF), was synthesized as follows.

BFPT (0.6907 g, 2.00 mmol) and bisphenol AF (0.6725 g, 2.0) mmol) were placed into a two-necked flask (50 mL) provided with a stirrer and a nitrogen gas inlet tube and potassium carbonate (0.3334 g, 2.40 mmol) as an alkali metal compound, N,N′-dimethylimidazolidone (DMI, 6.5 mL) as a neutral polar solvent, and toluene (20 mL) as an inert solvent component were added thereto. A Dean-Stark trap and a Liebig condenser were attached and a nitrogen gas atmosphere was created. The temperature was raised stepwise to 150° C. while stirring, toluene was refluxed at 150° C. for 2 hours, and the produced water was removed using the Dean-Stark trap. Thereafter, the temperature was raised to 190° C. and the result was stirred for 2 hours to remove toluene. Thereafter, polymerization was carried out at 190° C. for 2 hours. The result was left to cool to room temperature to obtain a brown, viscous polymerization solution. The polymer was precipitated by being poured into methanol, recovered, and then washed with hot methanol and dried under reduced pressure at room temperature. The obtained polymer was dissolved in tetramethyl urea (TMU) and poured into methanol to precipitate a white flaky polymer. The polymer was recovered and then dried under reduced pressure at room temperature.

As shown in BFPT-BisAF DMI in the table below, yield amount: 1.021 g, yield ratio: 80%, logarithmic viscosity: 0.98 dL/g (30° C., 0.5 g/dL NMP solution), number average molecular weight (Mₙ) measured using GPC as described above: 106,000, weight average molecular weight (M_{w}): 211,000, molecular weight distribution (M_{w}/Mₙ): 2.0.

The polymer was dissolved in TMU A and a 9 wt % solution was prepared. This solution was cast on a glass plate, heated stepwise to 160° C. under reduced pressure, and dried under reduced pressure at 160° C. for 3 hours to produce a colorless and transparent cast film (film thickness: 37 μm).

For this reference example, the analysis results using the instruments described above were

FT-IR (film, cm⁻¹): 3064 (Ar—H), 1595 (C═C), 1518 (C═N), 1506 (C═C), 1368 (C—N), 1248 (Ar—O).

¹H-MNR (chloroform solvent, ppm): 8.74-8.69 (m, 6H), 7.55-7.49 (m, 3H), 7.42 (d, 4H), 7.17 (d, 4H), 7.07 (d, 4H).

Cutoff wavelength: 343 nm, transmittance at 500 nm: 83%

Average refractive index (n): 1.621 (d-line), birefringence (Δn): 0.022 (d-line), dielectric constant (ε) calculated from refractive index: 2.63 (ε=n²).

### Reference Example 3

The compound of Reference Example 3, which was polyether (BFPT-BisPHTG), was synthesized as follows.

BFPT (0.6907 g, 2.00 mmol) and BisPHTG (0.6209 g, 2.00 mmol) were placed into a two-necked flask (50 mL) provided with a stirrer and a nitrogen gas inlet tube and potassium carbonate (0.3334 g, 2.40 mmol) as an alkali metal compound, N-methyl-2-pyrrolidone (NMP, 5.0 mL) as a neutral polar solvent, and toluene (20 mL) as an inert solvent component were added thereto. A Dean-Stark trap and a Liebig condenser were attached and a nitrogen gas atmosphere was created. The temperature was raised stepwise to 150° C. while stirring, toluene was refluxed at 150° C. for 2 hours, and the produced water was removed using the Dean-Stark trap. Thereafter, the temperature was raised to 190° C. and the result was stirred for 2 hours to remove toluene. Thereafter, polymerization was carried out at 190° C. for 3 hours. The result was left to cool to room temperature to obtain a brown, viscous polymerization solution. The polymer was precipitated by being poured into methanol, recovered, and then washed with hot methanol and dried under reduced pressure at room temperature. The obtained polymer was dissolved in NMP and poured into methanol to precipitate a white flaky polymer. The polymer was recovered and then dried under reduced pressure at room temperature.

As also shown in BFPT-BisPHTG NMP in the table below, yield amount: 1.163 g, yield ratio: 94%, logarithmic viscosity: 0.48 dL/g (30° C., 0.5 g/dL NMP solution), number average molecular weight (Mₙ) measured using GPC as described above: 74,000, weight average molecular weight (M_{w}): 135,000, and molecular weight distribution (M_{w}/Mₙ): 1.8.

This polymer was dissolved in tetramethyl urea (TMU) and a 15 wt % solution was prepared. This solution was cast on a glass plate, heated stepwise to 160° C. under reduced pressure, and dried at 160° C. under reduced pressure for 3 hours to produce a colorless and transparent cast film (film thickness: 38 μm).

For this reference example, the analysis results using the instruments described above were

FT-IR (film, cm⁻¹): 3062 (Ar—H), 2948 (C—H), 1593 (C═C), 1518 (C═N), 1504 (C═C), 1368 (C—N), 1242 (Ar—O).

¹H-NMR (CDCl₃, ppm): 8.68-8.65 (m, 6H), 7.52-7.48 (m, 3H), 7.49 (d, 2H), 7.23 (d, 2H), 7.05 (d, 4H), 7.00 (d, 2H), 6.94 (d, 2H), 2.71 (d, 1H), 2.47 (d, 1H), 2.04-2.01 (br, 1H), 1.96 (d, 1H), 1.41 (d, 1H), 1.20 (t, 1H), 0.99 (d, 6H), 0.89 (d, 1H), 0.43 (s, 6H).

Cutoff wavelength: 354 nm, transmittance at 500 nm: 81%

Average refractive index (n): 1.637 (d-line), birefringence (Δn): 0.006 (d-line), dielectric constant (ε) calculated from refractive index: 2.68 (ε=n²).

### Reference Example 4

The compound of Reference Example 4, which was polyether (BFPT-BisPIND), was synthesized as follows.

BFPT (0.6907 g, 2.00 mmol) and BisPIND (0.5368 g, 2.00 mmol) were placed into a two-necked flask (50 mL) provided with a stirrer and a nitrogen gas inlet tube and potassium carbonate (0.3334 g, 2.40 mmol) as an alkali metal compound, N-methyl-2-pyrrolidone (NMP, 5.0 mL) as a neutral polar solvent, and toluene (20 mL) as an inert solvent component were added thereto. A Dean-Stark trap and a Liebig condenser were attached and a nitrogen gas atmosphere was created. The temperature was raised stepwise to 150° C. while stirring, toluene was refluxed at 150° C. for 2 hours, and the produced water was removed using the Dean-Stark trap. Thereafter, the temperature was raised to 190° C. and the result was stirred for 2 hours to remove toluene. Thereafter, polymerization was carried out at 190° C. for 3 hours. The result was left to cool to room temperature to obtain a brown, viscous polymerization solution. The polymer was precipitated by being poured into methanol, recovered, and then washed with hot methanol and dried under reduced pressure at room temperature. The obtained polymer was dissolved in NMP and poured into methanol to precipitate a white flaky polymer. The polymer was recovered and then dried under reduced pressure at room temperature.

As also shown in BFPT-BisP-IND NMP in the table below, yield amount: 1.030 g, yield ratio: 90%, logarithmic viscosity: 0.96 dL/g (30° C., 0.5 g/dL NMP solution).

This polymer was dissolved in tetramethyl urea (TMU) and a 10 wt % solution was prepared. This solution was cast on a glass plate, heated stepwise to 160° C. under reduced pressure, and dried at 160° C. under reduced pressure for 3 hours to produce a colorless and transparent cast film (film thickness: 43 μm).

For this reference example, the analysis results using the instruments described above were

FT-IR (film, cm⁻¹): 3062 (Ar—H), 2958 (C—H), 1593 (C═C), 1518 (C═N), 1507 (C═C), 1368 (C—N), 1239 (Ar—O).

¹H-NMR (CDCl₃, ppm): 8.63-8.58 (m, 6H), 7.46-7.42 (m, 3H), 7.19-7.17 (m, 3H), 7.07-7.04 (m, 2H), 7.00-6.96 (m, 5H), 6.86 (s, 1H), 2.42 (d, 1H), 2.24 (d, 1H), 1.67 (s, 3H), 1.36 (s, 3H), 1.11 (s, 3H).

Cutoff wavelength: 352 nm, transmittance at 500 nm: 84%

Average refractive index (n): 1.653 (d-line), birefringence (Δn): 0.012 (d-line), dielectric constant (ε) calculated from refractive index: 2.73 (ε=n²).

### Reference Example 5

The compound of Reference Example 5, which was polyether (BFPT-BPFL), was synthesized as follows.

BFPT (0.6340 g, 1.84 mmol) and BPFL (0.6433 g, 1.84 mmol) were placed into a two-necked flask (50 mL) provided with a stirrer and a nitrogen gas inlet tube and potassium carbonate (0.3060 g, 2.20 mmol) as an alkali metal compound, N,N′-dimethylimidazolidone (DMI, 6.0 mL) as a neutral polar solvent, and toluene (20 mL) as an inert solvent component were added thereto. A Dean-Stark trap and a Liebig condenser were attached and a nitrogen gas atmosphere was created. The temperature was raised stepwise to 150° C. while stirring, toluene was refluxed at 150° C. for 2 hours, and the produced water was removed using the Dean-Stark trap. Thereafter, the temperature was raised to 190° C. and the result was stirred for 2 hours to remove toluene. Thereafter, polymerization was carried out at 190° C. for 2 hours. The result was left to cool to room temperature to obtain a brown, viscous polymerization solution. The polymer was precipitated by being poured into methanol, recovered, and then washed with hot methanol and dried under reduced pressure at room temperature. The obtained polymer was dissolved in tetramethyl urea (TMU) and poured into methanol to precipitate a white flaky polymer. The polymer was recovered and then dried under reduced pressure at room temperature.

The synthesized compound had yield amount: 1.043 g, yield ratio: 87%, logarithmic viscosity: 0.50 dL/g (30° C., 0.5 g/dL NMP solution), number average molecular weight (Mₙ): 46,000, weight average molecular weight (M_{w}): 88,000, and molecular weight distribution (M_{w}/Mₙ): 1.9.

This polymer was dissolved in TMU and a 12 wt % solution was prepared. This solution was cast on a glass plate, heated stepwise to 160° C. under reduced pressure, and dried at 160° C. under reduced pressure for 3 hours to produce a colorless and transparent cast film (film thickness: 64 μm).

For this reference example, the analysis results using the instruments described above were

FT-IR (film, cm⁻¹): 3062 (Ar—H), 1593 (C═C), 1519 (C═N), 1502 (C═C), 1368 (CN), 1241 (Ar—O).

¹H-NMR (CDCl₃, ppm): 8.65-8.64 (m, 6H), 7.75 (d, 2H), 7.52-7.48 (m, 3H), 7.42 (d, 2H), 7.35 (t, 2H), 7.28 (t, 2H), 7.17 (d, 4H), 7.07 (d, 4H), 6.93 (d, 4H).

Elemental analysis (C₄₉H₂₉O₂N₃)ₙ: Calculated values C, 84.25%; H, 4.46%; N, 6.41%; Measured values C, 84.18%; H, 4.51%; N, 6.43%.

Solubility: Soluble in N-methyl-2-pyrrolidone (NMP), tetramethyl urea (TMU), N,N′-dimethylimidazolidone (DMI), chloroform, tetrahydrofuran (THF), cyclopentanone, and cyclohexanone.

5% weight loss temperature: 515° C. (in air), 568° C. (in nitrogen), 10% weight loss temperature: 521° C. (in air), 578° C. (in nitrogen), char yield: 58% (in nitrogen, 800° C.), glass transition temperature (T_{g}): 309° C. (DSC), 331° C. (TMA), 306° C. (DMA).

Tensile breaking strength: 68 MPa, breaking elongation: 4.2%, initial tensile modulus: 5.0 GPa

Cutoff wavelength: 353 nm, transmittance at 500 nm: 82%

Average refractive index (n): 1.689 (d-line), birefringence (Δn): 0.003 (d-line), dielectric constant (ε) calculated from the refractive index: 2.85 (ε=n²)

Dielectric constant (Dₖ): 2.89 (TE mode, 10 GHz), 2.71 (TE mode, 20 GHz), Dielectric loss tangent (D_{f}): 0.0024 (TE mode, 10 GHz), 0.0025 (TE mode, 20 GHz).

### Reference Test Example 1: Examination of Polar Solvent and Polymerization Temperature

Production was performed under the same conditions as in Reference Example 2 (BFPT-BisAF), except that the polar solvent was changed to the three of NMP, TMU, and DMI, the amount of solvent was changed to 5 mL to 7.5 mL, and the polymerization time was changed to 170° C. to 190° C. and the polar solvent and the polymerization temperature were examined. Table 1 shows the results. The yield ratio (Yield) is the value after the reprecipitation. Logarithmic viscosity (ηᵢₙₕ) is a value measured at 30° C. using a 0.5 g/dL NMP solution.

TABLE 1

| | | | Solvent amount | Time | Yield ^{a)} | ηᵢₙₕ ^{b)} | | |
|---|---|---|---|---|---|---|---|---|
| Polymer | Solvent | Temp. | (mL) | (h) | (%) | (dL/g) | shape | Color |
| BFPT-BisAF | NMP | 190 | 5 | 15 | 47 | 0.50 | fibrous | beige |
| | TMU | 180 | 5 | 15 | 63 | 0.82 | fibrous | yellow |
| | DMI | 170 | 6.5 | 15 | 24 | 0.20 | powder | yellow |
| | | 180 | 6.5 | 15 | 29 | 0.34 | fibrous | yellow |
| | | | 5 | 2 | 52 | 0.88 | fibrous | white |
| | | 190 | 6.5 | 2 | 80 | 0.98 | fibrous | white |
| | | | 7.5 | 2 | 28 | 0.56 | fibrous | white |

As shown in Table 1, when DMI is used as the polar solvent, the amount of polar solvent is 5 mL (that is, the ratio of 25% by volume to 20 mL of toluene), and the polymerization temperature is 190° C., a high yield ratio and a high logarithmic viscosity were obtained. Furthermore, when the amount of polar solvent was increased to 6.5 mL, extremely high yield ratios and extremely high logarithmic viscosities were obtained. On the other hand, when the polymerization temperature was 170° C. to 180° C. and NMP or TMU was used as the polar solvent, the yield ratio and logarithmic viscosity decreased slightly and discoloration and the like were also observed, but production was possible.

### Reference Test Example 2: Synthesis Examination of Compounds of Reference Examples 1 to 4

The compounds of Reference Examples 1 to 4 were synthesized under the conditions described above. Each Reference Example was also synthesized using the same steps except that DMI was changed to NMP. The results are shown in Tables 2 and 3.

TABLE 2

| | | Time | Yield ^{b)} | ηᵢₙₕ ^{c)} | GPC ^{d)} | | | | |
|---|---|---|---|---|---|---|---|---|---|
| Polymer | solvent | (h) | (%) | (dL/g) | Mₙ × 10⁻⁴ | M_{w} × 10⁻⁴ | Mₙ/M_{w} | shape | Color |
| BFPT-BisA | NMP | 15 | 52 | 0.70 | 8.1 | 15.4 | 1.9 | fibrous | beige |
| | DMI | 2 | 58 | 0.54 | 3.0* | 6.2* | 2.1* | fibrous | white |
| BFPT-BisAF | NMP | 15 | 47 | 0.50 | 6.2 | 8.4 | 1.8 | fibrous | beige |
| | DMI | 2 | 80 | 0.98 | 10.6 | 21.1 | 2.0 | fibrous | white |

TABLE 3

| | | Time | Yield ^{b)} | ηᵢₙₕ ^{c)} | GPC ^{d)} | | | | |
|---|---|---|---|---|---|---|---|---|---|
| Polymer | solvent | (h) | (%) | (dL/g) | Mₙ × 10⁻⁴ | M_{w} × 10⁻⁴ | Mₙ/M_{w} | shape | Color |
| BFPT-BisP-HTG | NMP | 3 | 94 | 0.48 | 7.4 | 13.6 | 1.8 | fibrous | white |
| | DMI | 2 | 83 | 0.37 | | | | fibrous | yellow |
| BFPT-BisP-IND | NMP | 2 | 90 | 0.96 | 24.4 | 79.7 | 3.3 | fibrous | white |
| | DMI | 2 | 78 | 0.29 | | | | fibrous | yellow |

In addition to Reference Example 2 synthesized in Reference Test Example 1, it was possible to synthesize each of Reference Examples 1 to 4 with a high yield ratio of a certain level or more. In all of Reference Examples 1, 3, and 4, the yield ratio, logarithmic viscosity, and number average molecular weight (Mₙ) were higher and discoloration was less when NMP was used.

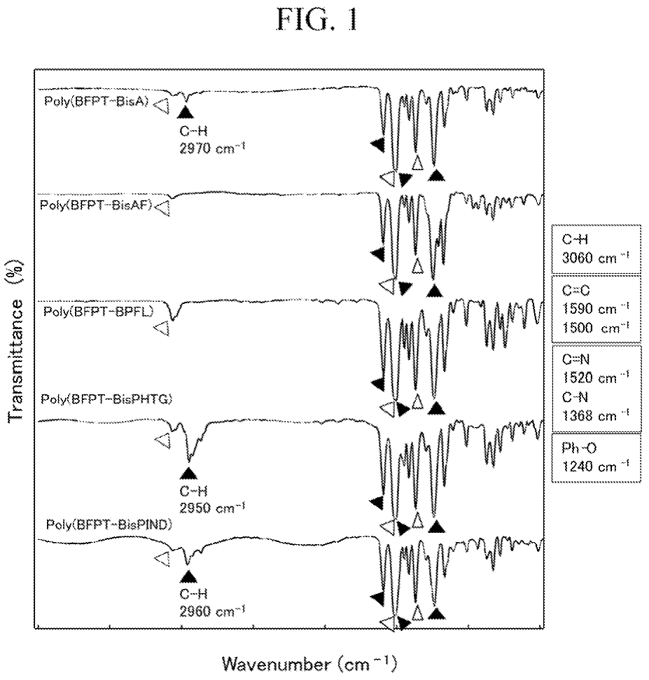

In addition, for the FT-IR spectra measured using the instrument described above, FIG. 1 shows the FT-IR spectra of Reference Examples 1 to 4 synthesized using DMI as a polar solvent.

In addition, Table 4 shows the results of elemental analysis for each reference example. In the table, Calcd is the calculated value and Found is the measured value.

TABLE 4
Poly(BFPT-BisA

| | |
|---|---|
| Elem. Anal. for | Calcd. C, 81.02%; H, 5.10%; N, 7.88%. |
| (C₃₆H₂₇O₂N₃)ₙ: | Found. C, 80.72%; H, 5.17%; N, 7.88%. |

Poly(BFPT-BisAF)

| | |
|---|---|
| Elem. Anal. for | Calcd. C, 67.40%; H, 3.29%; N, 6.55%. |
| (C₃₆H₂₁O₂N₃F₆)ₙ: | Found. C, 67.37%; H, 3.48%; N, 6.70%. |

Poly(BFPT-BisP-HTG)

| | |
|---|---|
| Elem. Anal. for | Calcd. C, 81.92%; H, 6.06%; N, 6.82%. |
| (C₄₂H₃₇O₂N₃)ₙ: | Found. C, 81.88%; H, 6.18%; N, 6.88%. |

Poly(BFPT-BisP-IND)

| | |
|---|---|
| Elem. Anal. for | Calcd. C, 81.65%; H, 5.45%; N, 7.32%. |
| (C₃₉H₃₁O₂N₃)ₙ: | Found. C, 81.41%; H, 5.56%; N, 7.23%. |

### Reference Test Example 3: Solubility of Compounds of Reference Examples 1 to 4

Table 5 and Table 6 show the results of examining the solubility of the compounds of Reference Examples 1 to 4 at room temperature or after performing heating. The solubility was measured at 10 mg/5.0 mL.

++: Dissolvable at room temperature.

+: Dissolved by heating.

+−: Only partially dissolved.

−: Insoluble.

TABLE 5

| polymer | NMP | TMU ^{b} | DMI ^{b} | DMAc | DMF | DMSO | SUL ^{b} | CHCl₃ |
|---|---|---|---|---|---|---|---|---|
| BFPT-BisA | ++ | ++ | ++ | − | − | − | − | +/− |
| BFPT-BisAF | ++ | ++ | ++ | ++ | +− | − | − | ++ |
| BFPT-BisP-HTG | ++ | ++ | ++ | +− | +− | − | − | ++ |
| BFPT-BisP-IND | ++ | ++ | ++ | +− | +− | − | − | ++ |

TABLE 6

| polymer | THF | Cyclopentanone | Cyclohexanone | γ-Butyrolactone | Aceton | EtOAc |
|---|---|---|---|---|---|---|
| BFPT-BisA | +− | +− | +− | − | | |
| BFPT-BisAF | ++ | ++ | ++ | +− | | |
| BFPT-BisP-HTG | ++ | ++ | ++ | +− | | |
| BFPT-BisP-IND | ++ | ++ | ++ | +− | | |

Reference Example 1 was soluble in N-methyl-2-pyrrolidone (NMP), tetramethyl urea (TMU), and N,N′-dimethylimidazolidone (DMI).

Reference Example 2 was soluble in N-methyl-2-pyrrolidone (NMP), tetramethyl urea (TMU), N,N′-dimethylimidazolidone (DMI), N,N-dimethylacetamide (DMAc), chloroform, tetrahydrofuran (THF), cyclopentanone, and cyclohexanone.

Reference Example 3 was soluble in N-methyl-2-pyrrolidone (NMP), tetramethyl urea (TMU), N,N′-dimethylimidazolidone (DMI), chloroform, tetrahydrofuran (THF), cyclopentanone, and cyclohexanone.

Reference Example 4 was soluble in N-methyl-2-pyrrolidone (NMP), tetramethyl urea (TMU), N,N′-dimethylimidazolidone (DMI), chloroform, tetrahydrofuran (THF), cyclopentanone, and cyclohexanone.

Although not shown in the table, Reference Example 5 was soluble in N-methyl-2-pyrrolidone (NMP), tetramethyl urea (TMU), N,N′-dimethylimidazolidone (DMI), chloroform, tetrahydrofuran (THF), cyclopentanone, and cyclohexanone.

In particular, it was shown that the Reference Examples are stable compounds, but soluble in certain organic solvents and excellent for reprecipitation purification and molding processing.

### Reference Test Example 4: Thermal Properties of Compounds of Reference Examples 1 to 4

The compounds of Reference Examples 1 to 4 were subjected to thermogravimetric analysis (TGA), differential scanning calorimetry measurement (DSC), thermomechanical analysis (TMA), and dynamic mechanical analysis (DMA), the thermal properties were examined, and the results are shown in Table 7 and Table 8.

Table 7 shows the glass transition temperature (T_{g}) and coefficient of thermal expansion (CTE). The glass transition temperature is a value measured by DSC in nitrogen at a heating rate of 20° C./min, a value measured by TMA in nitrogen at a heating rate of 10° C./min, and a value measured by DMA in nitrogen at a heating rate of 2° C./min. CTE is a value measured by TMA at 150° C. to 200° C.

T_{5%} and T_{10%} in Table 8 are the 5% reduction temperature and 10% reduction temperature and are values measured by TGA in nitrogen or air at a heating rate of 10° C./min. Char yield is the carbonization yield ratio in weight % at 800° C. in nitrogen.

| | T_{g} (° C.) | | | CTE ^{d)} | Film drying |
|---|---|---|---|---|---|
| Polymer | DSC ^{a)} | TMA ^{b)} | DMA ^{c)} | (ppm/° C.) | temp. (° C.) |
| BPPT-BisA | 245 | 250 | 239 | 87 | 235 |
| BFPT-BisAF | 248 | 280 | 249 | 72 | 235 |
| BFPT-BisP-HTG | 279 | 281 | 277 | 75 | 250 |
| BFPT-BisP-IND | 257 | 257 | 239 | 86 | 200 |

| | in N₂ ^{a)} (° C.) | | in air ^{a)} (° C.) | | Char yield ^{b)} (%) |
|---|---|---|---|---|---|
| Polymer | T_{5%} | T_{10%} | T_{5%} | T_{10%} | In N₂ |
| BFPT-BisA | 525 | 534 | 448 | 486 | 40 |
| BFPT-BisAF | 534 | 548 | 526 | 545 | 62 |
| BFPT-BisP-HTG | 511 | 520 | 480 | 496 | 25 |
| BFPT-BisP-IND | 513 | 520 | 512 | 522 | 30 |

From the results in Table 7, each Reference Example had a glass transition temperature of around 240° C. or higher, indicating high heat resistance.

From the results in Table 8, 5% of thermal decomposition and 10% of thermal decomposition occurred at 400° C. or higher in air and 500° C. or higher in nitrogen for all cases, indicating high thermal stability.

### Reference Test Example 5: Dielectric Properties of Compounds of Reference Examples 1 to 4

Table 9 shows the results of examining the dielectric properties of the compounds of Reference Examples 1 to 4 under the dielectric constant measurement conditions described above.

In Table 9, n indicates the refractive index measured by a prism coupler and was measured using F-line (486 nm), d-line (588 nm), and C-line (656 nm). The TE mode represents the in-plane refractive index of the film and the TM mode represents the out-of-plane refractive index of the film. V_{d} is the Abbe number, nₐᵥₑ is the average refractive index determined by nₐᵥₑ=[(2n_{TE}²+n_{TM}²)/3]^{1/2}, and n_{TE} and n_{TM} are the refractive indices of each mode measured with the d-line (588 nm). The dielectric constant (ε) is a value determined by ε=nₐᵥₑ². The dielectric constant (Dₖ) and dielectric loss tangent (D_{f}) are values measured with a cavity resonator.

TABLE 9

| | | n ^{b} | | | | | | [symbol] | 10 GHz TE | | 20 GHz TE | |
|---|---|---|---|---|---|---|---|---|---|---|---|---|
| Polymer | Mode ^{a} | n_{F} | n_{d} | n_{c} | v_{d} ^{c} | nₐᵥₑ ^{d} | ε^{e} | μm | Dₖ^{f} | D_{f}^{f} | Dₖ^{f} | D_{f}^{f} |
| BFPT-BisA | TE | | | | | | | | | | | |
| | TM | | | | | | | 38 | 2.58 | 0.00238 | 2.43 | 0.00267 |
| | | | | | | | | | 2.56* | 0.00269* | | |
| | Δn | | | | | | | | | | | |
| BFPT-BisAF | TE | 1.686 | 1.628 | 1.618 | 16 | | | | | | | |
| | TM | 1.628 | 1.606 | 1.597 | 22 | 1.621 | 2.63 | 42 | 2.65 | 0.00164 | 2.57 | 0.00183 |
| | | | | | | | | | 2.48* | 0.00180* | | |
| | Δn | 0.037 | 0.022 | 0.021 | | | | | | | | |
| BFPT-BisP-HTG | TE | 1.665 | 1.639 | 1.630 | 21 | | | | | | | |
| | TM | 1.656 | 1.633 | 1.623 | 21 | 1.637 | 2.68 | 38 | 2.57 | 0,00140 | 2.55 | 0.00165 |
| | Δn | 0.009 | 0.006 | 0.007 | | | | | | | | |
| BFPT-BisP-IND | TE | 1.094 | 1.657 | 1.646 | 16 | | | | | | | |
| | TM | 1.680 | 1.645 | 1.634 | 16 | 1.653 | 2.73 | 43 | 2.72 | 0.00180 | 2.59 | 0.00220 |
| | Δn | 0.014 | 0.012 | 0.012 | | | | | | | | |

Table 9 indicates that all of Reference Examples 1 to 4 had Dₖ (dielectric constant) value of 2.6 or less and D_{f} (dielectric loss tangent) value of 0.003 or less, which are sufficiently low.

Although not shown in the table, in Reference Example 5, the dielectric loss tangent (D_{f}) was 0.0024 (TE mode, 10 GHz) and 0.0025 (TE mode, 20 GHz) and values of 0.003 or less were seen; however, the dielectric constant (Dₖ) was 2.89 (TE mode, 10 GHz) and 2.71 (TE mode, 20 GHz), which were higher values than in Reference Examples 1 to 4.

### Reference Test Example 6: Mechanical Properties of Compounds of Reference Examples 1 to 4

Table 10 shows the results of examining the mechanical properties of the compounds of Reference Examples 1 to 4 under the tensile test conditions described above.

The tensile test was performed at a tensile speed of 10 mm/min and the film used was the 5 mm×30 mm cast film referred to in each synthesis step described above. Tₛ indicates tensile breaking strength, E_{b} indicates breaking elongation, and Tₘ indicates initial tensile modulus.

| | Thickness | Tₛ ^{a)} | E_{b} ^{b)} | Tₘ ^{c)} |
|---|---|---|---|---|
| polymer | (μm) | (MPa) | (%) | (GPa) |
| BFPT-BisA | 26 | 62 | 3.8 | 4.8 |
| BFPT-BisAF | 42 | 65 | 4.7 | 4.9 |
| BFPT-BisP-HTG | 39 | 60 | 3.8 | 4.5 |
| BFPT-BisP-IND | 47 | 50 | 3.4 | 4.5 |

In Table 10, all of Reference Examples 1 to 4 exhibited sufficient tensile mechanical properties.

### INDUSTRIAL APPLICABILITY

According to the present invention, it is possible to obtain a resin composition which has a low dielectric constant, a low dielectric loss tangent, high transparency, high solubility, and high heat resistance and is thus able to be used suitably as a low-dielectric material and a method for producing the same.

1.-16. (canceled)

17. A resin composition for a low-dielectric material, comprising:
a triazine-containing polyether compound having a repeating unit represented by General Formula (1),
wherein the triazine-containing polyether compound has,
a number average molecular weight (Mₙ) of 3×10³ to 40×10⁴,
a weight average molecular weight (M_{w}) of 6×10³ to 40×10⁴,
a dielectric constant Dₖ of 2.8 or less or a dielectric loss tangent D_{f} of 0.003 or less, and
a glass transition temperature of 200° C. or higher. 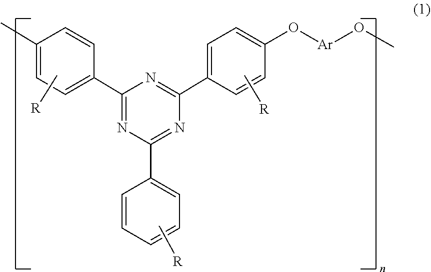
[in Formula (1), n is an integer of 2 to 200, and Ar represents phenylene groups, naphthylene groups or biphenylene groups, or, its bonded to other alkyl groups, alkylene groups, alkylidene groups, cycloalkyl groups, cycloalkylene groups, cycloalkylidene groups, aryl groups, arylene groups, fluorinated alkyl groups, fluorinated alkylene groups, fluorinated aryl groups or fluorinated arylene groups, and R represents hydrogen, a linear, branched, or cyclic aliphatic group, an aromatic group having or not having a substituent, a fluorinated aliphatic group, or a fluorinated aromatic group].

18. The resin composition for a low-dielectric material according to claim 17, wherein the Ar includes a triazine-containing polyether compound represented by any of General Formulas (2) to (15).

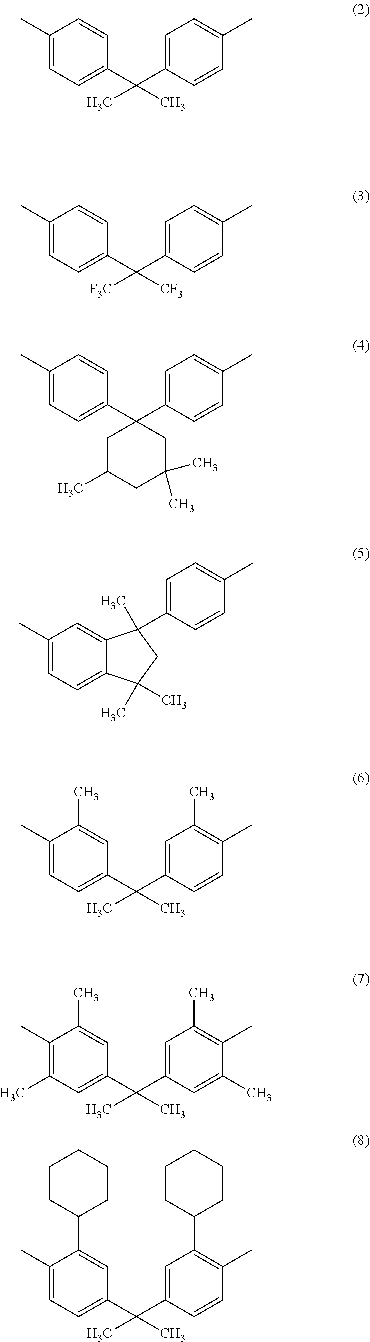

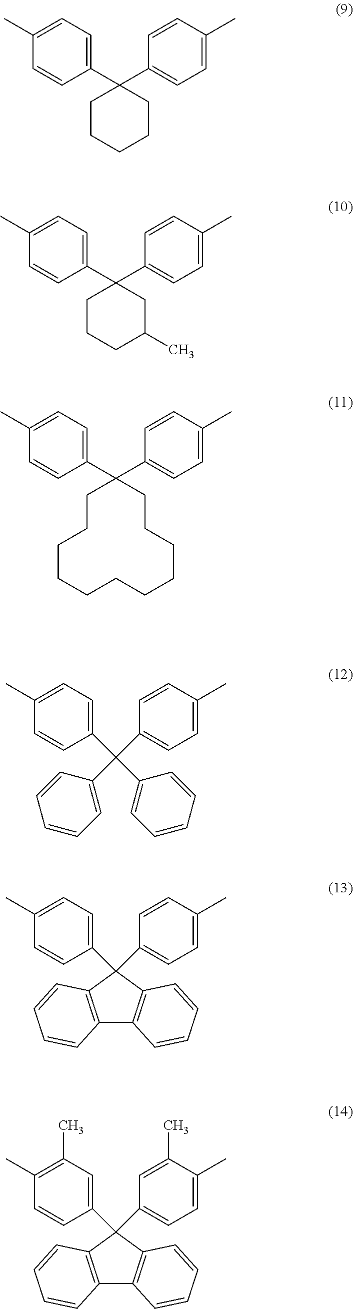

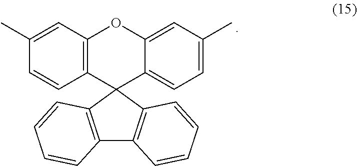

19. The resin composition for a low-dielectric material according to claim 17, further comprising:
the triazine-containing polyether compound, an epoxy resin, and a bismaleimide resin or a cyanate resin.

20. The resin composition for a low-dielectric material according to claim 17, further comprising:
an inorganic filler;
a modifier; or
a flame retardant.

21. The resin composition for a low-dielectric material according to claim 17, which is used in a device that transmits and receives high-frequency electromagnetic waves having a frequency of 0.1 to 500 GHz.

22. The resin composition for a low-dielectric material according to claim 17, which is used for a printed wiring board, a flexible printed wiring board, a sealing material for an electronic component, a resist ink, a conductive paste, an insulating material, or an insulating board.

23. A film for a multilayer substrate, comprising, on at least one surface:
an insulating material including the resin composition for a low-dielectric material according to claim 17.

24. A multilayer substrate comprising: two or more of the films for a multilayer substrate according to claim 23.

25. A method for producing the resin composition for a low-dielectric material according to claim 17, the method comprising:
mixing and polymerizing a compound represented by General Formula (16) and a compound represented by General Formula (17) to obtain a triazine-containing polyether compound represented by General Formula (18), 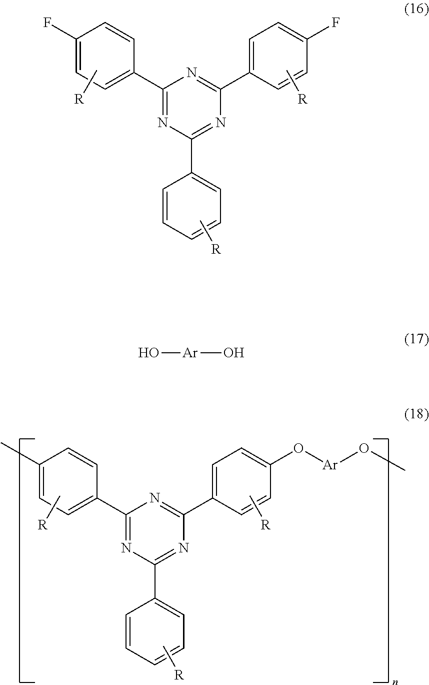
[in Formulas (16), (17), and (18), n is an integer of 2 or more, and Ar represents a divalent aromatic group having or not having a substituent, and R represents hydrogen, a linear, branched, or cyclic aliphatic group, an aromatic group having or not having a substituent, a fluorinated aliphatic group, or a fluorinated aromatic group].

26. The method for producing a resin composition for a low-dielectric material according to claim 25,
wherein the resin composition for a low-dielectric material is used as an insulating material between layers of a multilayer substrate, and
the triazine-containing polyether compound, an epoxy resin, a bismaleimide resin or a cyanate resin, a curing accelerator, and an organic solvent are mixed.

27. The method for producing a resin composition for a low-dielectric material according to claim 26, wherein an inorganic filler, a modifier, or a flame retardant are further mixed.

28. A method for producing a film for a multilayer substrate, the method comprising:
applying an insulating material including a resin composition for a low-dielectric material produced by the method for producing a resin composition for a low-dielectric material according to claim 26 onto at least one surface of a resin film.

29. A method for producing a multilayer substrate, the method comprising:
laminating two or more films for a multilayer substrate produced by the method for producing a film for a multilayer substrate of claim 28.

30. The resin composition for a low-dielectric material according to claim 18, wherein the Ar includes a triazine-containing polyether compound represented by any of General Formulas (5), (8), (10), (11), (14), or (15).

31. The resin composition for a low-dielectric material according to claim 17, uses for a resin composition for copper-clad laminates, an interlayer insulating material for build-up printed substrates, a build-up film, and the like. In addition, use is also possible as a resin composition for a sealing material for electronic components, a resin composition for resist ink, a bonding agent for friction materials, a conductive paste, a resin casting material, an adhesive, an insulating paint or a coating material.
